(19) United States
(12) Patent Application Publication
(10) Pub. No.: US 2023/0343947 A1
(43) Pub. Date: Oct. 26, 2023

(54) METHOD FOR FORMING ELECTRODE, SECONDARY BATTERY, ELECTRONIC DEVICE, AND VEHICLE

(71) Applicant: Semiconductor Energy Laboratory Co., Ltd., Atsugi-shi, Kanagawa-ken (JP)

(72) Inventors: Shunpei YAMAZAKI, Setagaya (JP); Tetsuji ISHITANI, Atsugi (JP); Yuji IWAKI, Isehara (JP); Shuhei YOSHITOMI, Ayase (JP)

(21) Appl. No.: 18/020,139

(22) PCT Filed: Aug. 5, 2021
(86) PCT No.: PCT/IB2021/057179

§ 371 Date: Feb. 7, 2023

(30) Foreign Application Priority Data
Aug. 20, 2020 (JP) 2020-139659

(51) Int. Cl. H01M 4/505; H01M 4/525; H01M 4/62; H01M 4/04; H01M 4/131

(52) U.S. Cl. CPC H01M 4/505; H01M 4/0404; H01M 4/0471; H01M 4/131; H01M 4/525; H01M 4/625; H01M 2004/021

(57) ABSTRACT

An active material particle with little deterioration is provided. A positive electrode active material particle with little deterioration is provided. The electrode includes a first particle group, a second particle group, and a third particle group. A median diameter of the first particle group is greater than a median diameter of the third particle group, and a median diameter of the second particle group is between the median diameter of the first particle group and the median diameter of the third particle group. The electrode is formed through a first step of forming a first mixture including the first particle group, the second particle group, the third particle group, and a solvent; a second step of applying the first mixture onto a current collector; and a third step of performing heating to volatilize the solvent.

### TECHNICAL FIELD

Embodiments of the present invention relate to a secondary battery including an active material particle and a manufacturing method thereof. Other embodiments of the present invention relate to an electrode including an active material particle and a formation method thereof. Other embodiments of the present invention relate to a secondary battery including an electrode and the like. Other embodiments of the present invention relate to an electronic device, a movable body, and the like each including a secondary battery.

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device, a vehicle, a movable body, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical 35 equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today’s information society.

Thus, improvement of a positive electrode active material has been studied to increase the cycle performance and the capacity of the lithium-ion secondary battery (Patent Document 1).

The performances required for a power storage device are safe operation and longer-term reliability under various environments, for example.

As a method for forming a positive electrode active material for a lithium-ion secondary battery with high capacity and excellent charge and discharge cycle performance, a technique of, after synthesizing lithium cobalt oxide, adding lithium fluoride and magnesium fluoride thereto and performing mixing and heating has been researched (Patent Document 1).

Crystal structures of positive electrode active materials have also been researched (Non-Patent Document 1 to Non-Patent Document 3). The physical properties of fluorides such as fluorite (calcium fluoride) have been researched for a long time (Non-Patent Document 4). With use of the ICSD (Inorganic Crystal Structure Database) described in Non-Patent Document 3, a research has been conducted to analyze X-ray diffraction (XRD) of the crystal structure of a positive electrode active material.

### REFERENCES

### Patent Documents

[Patent Document 1] Japanese Published Patent Application No. 2018-206747
[Patent Document 2] Japanese Published Patent Application No. 2018-088407
[Patent Document 3] PCT International Publication No. 2020/128699

### Non-Patent Documents

[Non-Patent Document 1] Toyoki Okumura et al., “Correlation of lithium ion distribution and X-ray absorption near-edge structure in O3— and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0 ≤ x ≤ 1.0)”, Physical Review B, 80 (16), 2009, 165114.
[Non-Patent Document 3] Zhaohui Chen et al., “Staging Phase Transitions in LiₓCoO₂”, Journalof The Electrochemical Society, 2002, 149 (12), A1604-A1609.
[Non-Patent Document 4] W. E. Counts et al., Journal of the American Ceramic Society, 1953, 36 12-17. Fig. 01471.

### SUMMARY OF THE INVENTION

### Problems to Be Solved by the Invention

An object of one embodiment of the present invention is to provide an active material particle with little deterioration. Another object of one embodiment of the present invention is to provide a positive electrode active material particle with little deterioration. Another object of one embodiment of the present invention is to provide a novel active material particle. Another object of one embodiment of the present invention is to provide a novel particle.

Another object of one embodiment of the present invention is to provide an electrode with little deterioration. Another object of one embodiment of the present invention is to provide a positive electrode with little deterioration. Another object of one embodiment of the present invention is to provide a novel electrode.

Another object of one embodiment of the present invention is to provide a secondary battery with a high charge voltage. Another object of one embodiment of the present invention is to provide a secondary battery with high discharge capacity. Another object of one embodiment of the present invention is to provide a secondary battery with little deterioration. Another object of one embodiment of the present invention is to provide a novel secondary battery

Another object of one embodiment of the present invention is to provide a novel power storage device.

Another object of one embodiment of the present invention is to provide a method for forming an electrode with little deterioration.

Note that the description of these objects does not preclude the existence of other objects. In one embodiment of the present invention, there is no need to achieve all these objects. Other objects can be derived from the description of the specification, the drawings, and the claims.

### Means for Solving the Problems

One embodiment of the present invention is a method for forming an electrode including a first particle group, a second particle group, and a third particle group. A median diameter of the first particle group is greater than a median diameter of the third particle group, and a median diameter of the second particle group is between the median diameter of the first particle group and the median diameter of the third particle group. The method includes: a first step of forming a first mixture including the first particle group, the second particle group, the third particle group, and a solvent; a second step of applying the first mixture onto a current collector; and a third step of performing heating to volatilize the solvent.

One embodiment of the present invention is a method for forming an electrode, which includes: a first step of forming a first mixture including a first particle group with a median diameter greater than or equal to 15 µm, a third particle group with a median diameter greater than or equal to 50 nm and less than or equal to 8 µm, a second particle group with a median diameter less than the median diameter of the first particle group and greater than the median diameter of the third particle group, a graphene compound, and a solvent; a second step of applying the first mixture onto a current collector; and a third step of performing heating to volatilize the solvent. The median diameters are each 50%D obtained by particle size distribution measurement using a laser diffraction and scattering method. The first particle group includes lithium, cobalt, magnesium, and oxygen. The second particle group includes lithium, cobalt, magnesium, and oxygen. The third particle group includes lithium, cobalt, and oxygen. When concentrations of cobalt and magnesium are obtained by analyzing the first particle group by XPS and the concentration of cobalt is assumed to be 1, the concentration of magnesium is greater than or equal to 0.1 and less than or equal to 1.5. When concentrations of cobalt and magnesium are obtained by analyzing the second particle group by XPS and the concentration of cobalt is assumed to be 1, the concentration of magnesium is greater than or equal to 0.1 and less than or equal to 1.5 and less than the concentration of magnesium obtained by analyzing the first particle group by XPS.

In the above-described structure, a concentration of magnesium is preferably higher in a surface portion than in an inner portion in a first particle included in the first particle group, and a concentration of magnesium is preferably higher in a surface portion than in an inner portion in a second particle included in the second particle group.

In the above-described structure, the first particle group preferably includes aluminum, a concentration of aluminum is preferably higher in the surface portion than in the inner portion in the first particle, the second particle group preferably includes aluminum, and a concentration of aluminum is preferably higher in the surface portion than in the inner portion in the second particle.

In the above-described structure, when weights of the first particle group, the second particle group, and the third particle group in the first mixture are referred to as Mx1, Mx2, and Mx3, respectively, and a sum of Mx1, Mx2, and Mx3 is assumed to be 100, Mx3 is preferably greater than or equal to 5 and less than or equal to 20.

In the above-described structure, the third particle group preferably includes magnesium. When concentrations of cobalt and magnesium are obtained by analyzing the third particle group by XPS and the concentration of cobalt is assumed to be 1, the concentration of magnesium is preferably greater than or equal to 0.1 and less than or equal to 1.5.

One embodiment of the present invention is a secondary battery including a positive electrode and a negative electrode. The positive electrode includes a first particle with a particle diameter greater than or equal to 15 µm, a third particle with a particle diameter greater than or equal to 50 nm and less than or equal to 8 µm, a second particle with a particle diameter greater than the particle diameter of the third particle and less than the particle diameter of the first particle, and a graphene compound. The first particle includes lithium, cobalt, magnesium, and oxygen. The second particle includes lithium, cobalt, magnesium, and oxygen. The third particle includes lithium, cobalt, and oxygen. In the first particle, a concentration of the magnesium is higher in a surface portion than in an inner portion. In the second particle, a concentration of the magnesium is higher in a surface portion than in an inner portion. The concentration of the magnesium in the surface portion of the first particle is higher than the concentration of the magnesium in the surface portion of the second particle.

In the above-described structure, the third particle preferably includes magnesium, and the concentration of the magnesium in the surface portion of the second particle is preferably higher than a concentration of the magnesium in a surface portion of the third particle.

One embodiment of the present invention is a secondary battery including a positive electrode and a negative electrode. The positive electrode includes a first particle with a particle diameter greater than or equal to 15 µm, a third particle with a particle diameter greater than or equal to 50 nm and less than or equal to 8 µm, a second particle with a particle diameter greater than the particle diameter of the third particle and less than the particle diameter of the first particle, and a graphene compound. The first particle includes lithium, cobalt, aluminum, and oxygen. The second particle includes lithium, cobalt, aluminum, and oxygen. The third particle includes lithium, cobalt, and oxygen. In the first particle, a concentration of the aluminum is higher in a surface portion than in an inner portion. In the second particle, a concentration of the aluminum is higher in a surface portion than in an inner portion. The concentration of the aluminum in the surface portion of the first particle is higher than the concentration of the aluminum in the surface portion of the second particle.

In the above-described structure, the third particle preferably includes aluminum, and the concentration of the aluminum in the surface portion of the second particle group is preferably higher than a concentration of the aluminum in a surface portion of the third particle.

In the above-described structure, the graphene compound preferably includes a vacancy formed of a many-membered ring which is a seven- or more-membered ring of carbon.

In the above-described structure, the first particle preferably includes one or more selected from fluorine, bromine, boron, zirconium, and titanium.

In the above-described structure, the second particle preferably includes one or more selected from fluorine, bromine, boron, zirconium, and titanium.

In the above-described structure, the third particle preferably includes nickel. When a sum of concentrations of cobalt, manganese, nickel, and aluminum in the third particle is assumed to be 100, the concentration of nickel is preferably greater than or equal to 33.

One embodiment of the present invention is an electronic device including the secondary battery described in any of the above.

One embodiment of the present invention is a vehicle including the secondary battery described in any of the above.

One embodiment of the present invention is a movable body including the secondary battery described in any of the above.

### Effect of the Invention

With one embodiment of the present invention, an active material particle with little deterioration can be provided. With one embodiment of the present invention, a positive electrode active material particle with little deterioration can be provided. With one embodiment of the present invention, a novel active material particle can be provided. With one embodiment of the present invention, a novel particle can be provided.

With one embodiment of the present invention, an electrode with little deterioration can be provided. With one embodiment of the present invention, a positive electrode with little deterioration can be provided. With one embodiment of the present invention, a novel electrode can be provided.

With one embodiment of the present invention, a secondary battery with a high charge voltage can be provided. With one embodiment of the present invention, a secondary battery with high discharge capacity can be provided. With one embodiment of the present invention, a secondary battery with little deterioration can be provided. With one embodiment of the present invention, a novel secondary battery can be provided.

With one embodiment of the present invention, a novel power storage device can be provided.

With one embodiment of the present invention, a method for forming an electrode with little deterioration can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A, FIG. 1B, and FIG. 1C are diagrams illustrating examples of formation methods.

FIG. 2 is a diagram illustrating an example of a formation method.

FIG. 3A and FIG. 3B are diagrams illustrating examples of formation methods.

FIG. 4A and FIG. 4B are diagrams illustrating examples of formation methods.

FIG. 5A and FIG. 5B are diagrams illustrating an example of an electrode.

FIG. 6A is a top view of a positive electrode active material of one embodiment of the present invention, and FIG. 6B is a cross-sectional view of the positive electrode active material of one embodiment of the present invention.

FIG. 7 is a diagram illustrating the charge depth and crystal structures of a positive electrode active material of one embodiment of the present invention.

FIG. 8 shows XRD patterns calculated from crystal structures.

FIG. 9 is a diagram illustrating the charge depth and crystal structures of a positive electrode active material of a comparative example.

FIG. 10 shows XRD patterns calculated from crystal structures.

FIG. 11A to FIG. 11C are graphs showing lattice constants calculated from XRD.

FIG. 12A to FIG. 12C are graphs showing lattice constants calculated from XRD.

FIG. 13 is a graph showing a relation between capacity and charge voltage.

FIG. 14A and FIG. 14B are graphs of dQ/dV vs V of secondary batteries of embodiments of the present invention. FIG. 14C is a graph of dQ/dV vs V of a secondary battery of a comparative example.

FIG. 15A and FIG. 15B are diagrams illustrating examples of a secondary battery.

FIG. 16A to FIG. 16C are diagrams illustrating an example of a secondary battery.

FIG. 17A and FIG. 17B are diagrams illustrating an example of a secondary battery.

FIG. 18A to FIG. 18C are diagrams illustrating a coin-type secondary battery.

FIG. 19A to FIG. 19D are diagrams illustrating cylindrical secondary batteries.

FIG. 20A and FIG. 20B are diagrams illustrating an example of a secondary battery.

FIG. 21A, FIG. 21B, FIG. 21C, and FIG. 21D are diagrams illustrating examples of secondary batteries.

FIG. 22A and FIG. 22B are diagrams illustrating examples of secondary batteries.

FIG. 23 is a diagram illustrating an example of a secondary battery.

FIG. 24A to FIG. 24C are diagrams illustrating a laminated secondary battery.

FIG. 25A and FIG. 25B are diagrams illustrating a laminated secondary battery.

FIG. 26 is an external view of a secondary battery.

FIG. 27 is an external view of a secondary battery.

FIG. 28A to FIG. 28C are diagrams illustrating a method for manufacturing a secondary battery.

FIG. 29A, FIG. 29B1, FIG. 29B2, FIG. 29C, and FIG. 29D are diagrams illustrating a bendable secondary battery.

FIG. 30A and FIG. 30B are diagrams illustrating a bendable secondary battery.

FIG. 31A to FIG. 31H are diagrams illustrating examples of electronic devices.

FIG. 32A to FIG. 32C are diagrams illustrating an example of an electronic device.

FIG. 33 is a diagram illustrating examples of electronic devices.

FIG. 34A to FIG. 34C are diagrams illustrating examples of electronic devices.

FIG. 35A to FIG. 35C are diagrams illustrating examples of electronic devices.

FIG. 36A to FIG. 36C are diagrams illustrating examples of vehicles.

FIG. 37A and FIG. 37B are graphs showing results on particle size distribution.

FIG. 38A and FIG. 38B are graphs showing results on particle size distribution.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing a minus sign (-) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “()”, and a set plane having equivalent symmetry is denoted with “{ }”.

In this specification and the like, segregation refers to a phenomenon in which in a solid made of a plurality of elements (e.g., A, B, and C), a certain element (e.g., B) is spatially non-uniformly distributed.

In this specification and the like, the layered rock-salt crystal structure of a composite oxide including lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, an O3′ type crystal structure of a composite oxide including lithium and a transition metal belongs to a space group R-3m, and is a crystal structure in which an ion of cobalt, magnesium, or the like is coordinated to six oxygen atoms. Note that in the O3′ type crystal structure, a light element such as lithium is sometimes coordinated to four oxygen atoms.

The O3′ type crystal structure can also be regarded as a crystal structure that includes Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, simple and pure lithium cobalt oxide or a layered rock-salt positive electrode active material including a large amount of cobalt is known not to have this crystal structure generally.

Anions of a layered rock-salt crystal and anions of a rock-salt crystal have cubic closest packed structures (face-centered cubic lattice structures). Anions of a pseudo-spinel crystal are also presumed to have cubic closest packed structures. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the O3′ type crystal is R-3m, which is different from that of a cubic crystal structure such as the space group Fm-3m of the rock-salt crystal; thus, the Miller index of the crystal plane satisfying the above conditions in the layered rock-salt crystal and the O3′ type crystal is different from that in the rock-salt crystal. In this specification, a state where the orientations of the cubic closest packed structures composed of anions in the layered rock-salt crystal, the O3′ type crystal, and the rock-salt crystal are aligned is referred to as a state where crystal orientations are substantially aligned in some cases.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In the TEM image and the like, alignment of cations and anions can be observed as repetition of bright lines and dark lines. When the orientations of cubic closest packed structures in the layered rock-salt crystal and the rock-salt crystal are aligned, a state where the angle made by the repetition of bright lines and dark lines in the layered rock-salt crystal and the rock-salt crystal is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all the lithium that can be inserted and extracted is inserted is 0, and the charge depth obtained when all the lithium that can be inserted and extracted in a positive electrode active material is extracted is 1.

In addition, in this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a charge depth of greater than or equal to 0.7 and less than or equal to 0.9 may be referred to as a positive electrode active material charged with high voltage.

Similarly, discharging refers to transfer of lithium ions from a negative electrode to a positive electrode in a battery and transfer of electrons from a negative electrode to a positive electrode in an external circuit. Discharging of a positive electrode active material refers to insertion of lithium ions. Furthermore, a positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material.

In this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

In this specification, for example, when the shape of an object is described with the use of a term such as “diameter”, “particle diameter”, “dimension”, “size”, or “width”, the term can be regarded as the length of one side of a minimal cube where the object fits, or an equivalent circle diameter of a cross section of the object. The term “equivalent circle diameter of a cross section of the object” refers to the diameter of a perfect circle having the same area as that of the cross section of the object.

### Embodiment 1

In this embodiment, an electrode and the like of embodiments of the present invention are described.

### [Electrode]

An electrode of one embodiment of the present invention includes a first particle, a second particle, and a third particle. The particle diameter of the first particle is greater than the particle diameter of the second particle. The particle diameter of the second particle is greater than the particle diameter of the third particle. The particle diameter of the first particle, the particle diameter of the second particle, and the particle diameter of the third particle are referred to as D1, D2, and D3, respectively. The first particle, the second particle, and the third particle include a lithium composite oxide. The first particle, the second particle, and the third particle each function as an active material.

By including three kinds of particles with different particle diameters, the electrode of one embodiment of the present invention can have high resistance against contraction of the active material and a structure change of a crystal included in the active material by charging and discharging. The three kinds of particles with different particle diameters serve like cement, gravel, and sand in concrete, for example and enable a stress-resistant structure and favorable adhesiveness, which is preferable.

When the electrode of one embodiment of the present invention includes the first particle, which is a large particle, the charging rate of the electrode can be increased and the density of the electrode can be increased. When the electrode of one embodiment of the present invention includes the third particle, which is a small particle, the third particle can be positioned in a space between large particles and the volume of the space can be reduced; accordingly, the charging rate can be increased and the density of the electrode can be increased. Furthermore, when the electrode of one embodiment of the present invention includes the second particle, which is larger than the third particle and smaller than the first particle, stress owing to contraction of the active material by charging and discharging is relieved in some cases. Moreover, when the electrode of one embodiment of the present invention includes the second particle, which is larger than the third particle and smaller than the first particle, stress owing to pressing in forming the electrode is relieved in some cases.

D1 is preferably greater than or equal to 15 µm, D3 is preferably less than or equal to 10 µm, and D2 is preferably less than D1 and greater than D3.

Alternatively, D1 is preferably greater than or equal to 20 µm, D3 is preferably greater than or equal to 50 nm and less than or equal to 8 µm and further preferably greater than or equal to 100 nm and less than or equal to 7 µm, and D2 is preferably greater than or equal to 9 µm and less than or equal to 25 µm and smaller than D1.

Alternatively, D1 is preferably greater than or equal to 20 µm, D3 is preferably greater than or equal to 50 nm and less than or equal to 8 µm and further preferably greater than or equal to 100 nm and less than or equal to 7 µm, and D2 is preferably greater than 8 µm and less than 20 µm and further preferably greater than 7 µm and less than 20 µm.

The electrode of one embodiment of the present invention preferably includes a graphene compound. The graphene compound can function as a conductive material. A plurality of graphene compounds form a three-dimensional conductive path in the electrode and can increase the conductivity of the electrode. Because the graphene compounds can cling to the particles in the electrode, the collapse of the particles in the electrode can be suppressed and the electrode strength can be increased. The graphene compounds have a thin sheet shape and can form the excellent conductive path even though occupying a small volume in the electrode, whereby the volume of the active material in the electrode can be increased and the capacity of the secondary battery can be increased. The graphene compound is described later.

By including the three kinds of particles with different sizes as the active material, the electrode of one embodiment of the present invention can achieve excellent cycle performance even at a high charge voltage.

The particles included in the electrode of one embodiment of the present invention preferably include one or more selected from magnesium, fluorine, bromine, aluminum, nickel, boron, zirconium, and titanium in their surface portions. Furthermore, the first particle, the second particle, and the third particle are preferably different from each other in the concentration of one or more selected from magnesium, fluorine, bromine, aluminum, nickel, boron, zirconium, and titanium in their surface portions. Moreover, the particles of one embodiment of the present invention preferably include one or more selected from magnesium, fluorine, bromine, aluminum, nickel, boron, zirconium, and titanium in a grain boundary and the vicinity thereof as well as the surface portions.

It is preferable that the particles of one embodiment of the present invention include magnesium in their surface portions. It is preferable that the particles of one embodiment of the present invention include magnesium in their surface portions and further include aluminum and/or boron. It is preferable that the particles of one embodiment of the present invention include magnesium in their surface portions, further include aluminum and/or boron, and further include fluorine and/or bromine.

Since a large particle can have a small specific surface area, it can inhibit capacity reduction due to a side reaction with an electrolyte. The large particle also has advantages such as easily carrying an active material layer in application to a current collector and easily achieving the electrode strength. Using the large particle can increase the powder packing density (PPD).

The large particle includes a plurality of crystal grains in some cases and thus may have a grain boundary in an inner portion of the particle. A crack originating from the grain boundary may occur in the particle. When a crack occurs, the area of reaction with the electrolyte increases, and the reaction amount of the side reaction is increased in some cases. Moreover, the crack causes the collapse of particles from the electrode and decreases the electrode strength in some cases. Therefore, fewer grain boundaries in the particle are preferred. In particular, in the case where the charge voltage is high, the amount of lithium that is inserted to and extracted from the active material is increased, and thus crystal contraction due to charging and discharging significantly occurs and a crack may occur more easily. In the active material having a layered structure in which lithium is positioned between the layers, stress in a direction in which the distance between the layers expands and contracts is generated due to charging and discharging, whereby a crack tends to occur along the layers, for example.

The particles of one embodiment of the present invention are each, for example, a lithium composite oxide which has the layered rock-salt structure, is represented by the space group R-3m, and is represented by LiMO₂ (M is one or more metals including cobalt). Alternatively, the particles of one embodiment of the present invention include the lithium composite oxide, for example. Stress is generated in the lithium composite oxide; for example, stress is generated more significantly in the c-axis direction.

Here, the composition of the lithium composite oxide represented by LiMO₂ is not limited to Li:M:O = 1:1:2. As the lithium composite oxide represented by LiMO₂, lithium cobalt oxide, lithium nickel-cobalt-manganese oxide, lithium nickel-cobalt-aluminum oxide, lithium nickel-cobalt-manganese-aluminum oxide, and the like can be given.

Using cobalt at greater than or equal to 75 atomic%, preferably greater than or equal to 90 atomic%, further preferably greater than or equal to 95 atomic% as the element M brings many advantages such as relatively easy synthesis, easy handling, and excellent cycle performance.

Using nickel at greater than or equal to 33 atomic%, preferably greater than or equal to 60 atomic%, further preferably greater than or equal to 80 atomic% as the element M is preferable because in that case, the cost of the raw materials might be lower than that in the case of using a large amount of cobalt and charge and discharge capacity per weight might be increased.

When nickel at greater than or equal to 33 atomic%, preferably greater than or equal to 60 atomic%, further preferably greater than or equal to 80 atomic% is used as the element M, the particle diameter is reduced in some cases. Therefore, the above-described third particle preferably includes nickel as the element M at greater than or equal to 33 atomic%, preferably greater than or equal to 60 atomic%, further preferably greater than or equal to 80 atomic%, for example.

Moreover, when nickel is partly included as the element M together with cobalt, a shift in a layered structure formed of octahedrons of cobalt and oxygen is sometimes inhibited. The inhibition of the shift enables higher stability of the crystal structure particularly in a high-temperature charged state in some cases, which is preferable. This is presumably because nickel is easily diffused into the inner portion of lithium cobalt oxide and exists in a cobalt site at the time of discharging but can be positioned in a lithium site owing to cation mixing at the time of charging. Nickel existing in the lithium site at the time of charging functions as a pillar supporting the layered structure formed of octahedrons of cobalt and oxygen and presumably contributes to stabilization of the crystal structure.

Note that manganese is not necessarily included as the element M. In addition, nickel is not necessarily included. Furthermore, cobalt is not necessarily included.

At the time of charging, lithium is extracted from the particle surface; accordingly, the surface portion of the particle has a lower lithium concentration than the inner portion and tends to suffer crystal structure collapse.

The particles of one embodiment of the present invention include lithium, the element M, and oxygen. The particles of one embodiment of the present invention include the lithium composite oxide represented by LiMO₂ (M is one or more metals including cobalt). The particles of one embodiment of the present invention include one or more selected from magnesium, fluorine, aluminum, and nickel in their surface portions. When the particles of one embodiment of the present invention include one or more of these elements in the surface portions, a structure change owing to charging and discharging is reduced and generation of a crack can be inhibited in the surface portions of the particles. Furthermore, an irreversible structure change in the surface portions of the particles can be inhibited, whereby capacity reduction due to the repetitive charging and discharging can be inhibited. The concentrations of these elements in the surface portion are preferably higher than the concentrations of these elements in the whole particle. In the surface portions of the particles of one embodiment of the present invention, the lithium composite oxide may have a structure in which one or more selected from magnesium, fluorine, aluminum, and nickel is substituted for some atoms, for example.

In this specification and the like, a surface portion of a particle of an active material or the like is a region that is less than or equal to 50 nm, preferably less than or equal to 35 nm, further preferably less than or equal to 20 nm, most preferably less than or equal to 10 nm inward from the surface, for example. A plane generated by a split or a crack may also be referred to as a surface. In addition, a region which is deeper than the surface portion is referred to as an inner portion.

Moreover, the particles of one embodiment of the present invention preferably include one or more selected from magnesium, fluorine, aluminum, and nickel in a grain boundary and the vicinity thereof as well as the surface portions. The concentrations of these elements in the grain boundary and the vicinity thereof are preferably higher than the concentrations of these elements in the whole particle.

Note that in this specification and the like, a crystal grain boundary refers to a portion where particles adhere to each other, a portion where crystal orientation changes inside a particle (including the center), a portion including many defects, a portion with a disordered crystal structure, or the like, for example. The grain boundary is one of plane defects. The vicinity of a crystal grain boundary refers to a region of approximately 10 nm from the grain boundary. In this specification and the like, the term “defect” refers to a crystal defect or a lattice defect. Defects include a point defect, a dislocation, a stacking fault, which is a two-dimensional defect, and a void, which is a three-dimensional defect.

When the surface portion includes magnesium, the change in the crystal structure can be reduced effectively. In addition, when the surface portion includes magnesium, it is expected to increase the corrosion resistance to hydrofluoric acid generated by the decomposition of the electrolyte solution.

In the surface portion of the above-described lithium composite oxide represented by LiMO₂ or the like, at least one of magnesium atoms probably substitutes for a lithium atom. When the surface portion includes magnesium, displacement of a layer due to charging and discharging can be inhibited, for example. Furthermore, when the surface portion includes magnesium, extraction of oxygen due to charging and discharging can be inhibited. Furthermore, when the surface portion includes magnesium, the structure is stabilized; accordingly, dissolution of cobalt to the outside of the particle can be inhibited.

In the case where a magnesium atom substitutes for a lithium atom, the number of lithium atoms contributing to charging and discharging of the secondary battery is reduced. Unevenly distributing magnesium in the surface portion and lowering the concentration of magnesium in the inner portion can minimize the reduction in the number of lithium atoms contributing to charging and discharging, whereby charge and discharge cycle performance can be improved while a reduction in discharge capacity of the secondary battery is suppressed.

When the surface portion includes aluminum, the change in the crystal structure can be reduced more effectively.

In the surface portion of the above-described lithium composite oxide represented by LiMO₂ or the like, at least one of aluminum atoms probably substitutes for a cobalt atom. Since the valence of aluminum hardly changes from 3, lithium extraction is unlikely to occur in the vicinity of aluminum and the amount of lithium contributing to charging and discharging is reduced. Unevenly distributing aluminum in the surface portion and lowering the concentration of aluminum in the inner portion can improve charge and discharge cycle performance while a reduction in discharge capacity of the secondary battery is suppressed.

When the surface portion includes fluorine, cobalt has a valence of 2 in the vicinity of fluorine and lithium extraction is likely to occur, in some cases. When the surface portion, which is a region in contact with the electrolyte, includes fluorine, the corrosion resistance to hydrofluoric acid can be effectively increased.

In the case where the surface portion includes nickel, when lithium is extracted by charging, cation mixing occurs between nickel and a lithium site to stabilize the crystal structure. Nickel preferably exists at a low concentration in the inner portion of the particle as well as the surface portion.

Here, fewer grain boundaries of the particles can be achieved in some cases by setting the particle diameter to a desired size. For example, in some cases, lithium cobalt oxide can have fewer grain boundaries when the particle diameter is greater than or equal to 50 nm and less than or equal to 8 µm, preferably greater than or equal to 100 nm and less than or equal to 7 µm.In the case where fewer grain boundaries are possible, the concentration of one or more selected from magnesium, fluorine, aluminum, and nickel in the surface portion of the particle may be reduced in order to increase the discharge capacity of the secondary battery.

In the case where the particle diameter is smaller, the specific surface area is increased, which causes a more significant capacity reduction due to a side reaction with an electrolyte. In the case of forming an electrode using small particles, carrying an active material layer in application to a current collector may become difficult. Thus, in the electrode of one embodiment of the present invention, a mixture of particles with a large particle diameter and particles with a small particle diameter is preferably used as the active material.

The proportions of metals or the like in the whole particles of the lithium composite oxide can be measured with, for example, an ICP-MS (inductively coupled plasma mass spectrometer). The proportion of oxygen in the whole particles of the lithium composite oxide can be measured by, for example, EDX (energy dispersive X-ray spectroscopy). Alternatively, the proportion can be measured by ICP-MS combined with fusion gas analysis and valence evaluation of XAFS (X-ray absorption fine structure) analysis.

The proportions of elements in the surface portion, the inner portion, and the grain boundary in the particles of the lithium composite oxide can be measured by EDX, XPS, or the like, for example.

The number of magnesium atoms included in the whole first particle is preferably greater than or equal to 0.5 and less than or equal to 5 when the sum of cobalt, manganese, nickel, and aluminum atoms is assumed to be 100. The number of magnesium atoms included in the whole second particle is preferably greater than or equal to 0.5 and less than or equal to 5 when the sum of cobalt, manganese, nickel, and aluminum atoms is assumed to be 100.

The concentration of magnesium in the whole particle in the third particle is preferably lower than that in the second particle. The number of magnesium atoms included in the whole third particle is preferably less than or equal to 2 and further preferably less than or equal to 1.1 when the sum of cobalt, manganese, nickel, and aluminum atoms is assumed to be 100.

The number of aluminum atoms included in the whole first particle is preferably greater than or equal to 0.25 and less than or equal to 2.5 when the sum of cobalt, manganese, nickel, and aluminum atoms is assumed to be 100. The number of aluminum atoms included in the whole second particle is preferably greater than or equal to 0.25 and less than or equal to 2.5 when the sum of cobalt, manganese, nickel, and aluminum atoms is assumed to be 100.

The concentration of aluminum in the whole particle in the third particle is preferably lower than that in the second particle. The number of aluminum atoms included in the whole third particle is preferably less than or equal to 1 and further preferably less than or equal to 0.55 when the sum of cobalt, manganese, nickel, and aluminum atoms is assumed to be 100.

### <XPS>

A region that is approximately 2 nm to 8 nm (normally, approximately 5 nm) in depth from a surface can be analyzed by X-ray photoelectron spectroscopy (XPS); thus, the concentrations of elements in approximately half the surface portion can be quantitatively analyzed. The bonding states of the elements can be analyzed by narrow scanning. Note that the quantitative accuracy of XPS is approximately ±1 atomic% in many cases. The lower detection limit is approximately 1 atomic% but depends on the element.

In the XPS analysis, monochromatic aluminum can be used as an X-ray source, for example. An extraction angle is, for example, 45°.

In the XPS analysis performed on the first particle and the second particle, when the concentration of the element M is assumed to be 1, the relative value of the concentration of magnesium is preferably greater than or equal to 0.1 and less than or equal to 1.5. Furthermore, the relative value of the concentration of halogen such as fluorine is preferably greater than or equal to 0.1 and less than or equal to 1.5. When the concentration of the element M is assumed to be 1, the relative value of the concentration of magnesium in the second particle is preferably lower than that in the first particle. When the concentration of the element M is assumed to be 1, the relative value of the concentration of halogen such as fluorine in the second particle is preferably lower than that in the first particle.

In the XPS analysis performed on the third particle, when the concentration of the element M is assumed to be 1, the relative value of the concentration of magnesium is preferably less than or equal to 1.5 or less than 1.00, for example. When the concentration of the element M is assumed to be 1, the relative value of the concentration of magnesium in the third particle is preferably lower than that in the second particle. In some cases, the third particle does not include magnesium.

Alternatively, in the XPS analysis, when the concentration of cobalt is assumed to be 1, the relative value of the concentration of magnesium in the first particle and the second particle is preferably greater than or equal to 0.1 and less than or equal to 1.5, and the relative value of the concentration of halogen such as fluorine is preferably greater than or equal to 0.1 and less than or equal to 1.5. The relative value of the concentration of magnesium in the second particle is preferably lower than that in the first particle, and the relative value of the concentration of halogen such as fluorine in the second particle is preferably lower than that in the first particle. The relative value of the concentration of magnesium in the third particle is less than or equal to 1.5 or less than 1.00, for example. The relative value of the concentration of magnesium in the third particle is preferably lower than that in the second particle. In some cases, the third particle does not include magnesium.

Alternatively, in the XPS analysis, when the sum of concentrations of cobalt, manganese, nickel, and aluminum is assumed to be 1, the relative value of the concentration of magnesium in the first particle and the second particle is preferably greater than or equal to 0.1 and less than or equal to 1.5, and the relative value of the concentration of halogen such as fluorine is preferably greater than or equal to 0.1 and less than or equal to 1.5. The relative value of the concentration of magnesium in the second particle is preferably lower than that in the first particle, and the relative value of the concentration of halogen such as fluorine in the second particle is preferably lower than that in the first particle. The relative value of the concentration of magnesium in the third particle is less than or equal to 1.5 or less than 1.00, for example. The relative value of the concentration of magnesium in the third particle is preferably lower than that in the second particle. In some cases, the third particle does not include magnesium.

In addition, when the first particle, the second particle, and the third particle are analyzed with XPS, a peak indicating the bonding energy of fluorine with another element is preferably higher than or equal to 682 eV and lower than 685 eV, further preferably approximately 684.3 eV. This bonding energy is different from that of lithium fluoride (685 eV) and that of magnesium fluoride (686 eV). That is, when the first particle, the second particle, and the third particle include fluorine, bonding other than bonding of lithium fluoride and magnesium fluoride is preferable.

Furthermore, when the first particle, the second particle, and the third particle are analyzed by XPS, a peak indicating the bonding energy of magnesium with another element is preferably higher than or equal to 1302 eV and lower than 1304 eV, further preferably approximately 1303 eV. This bonding energy is different from that of magnesium fluoride (1305 eV) and is close to that of magnesium oxide. That is, when the first particle, the second particle, and the third particle include magnesium, bonding other than bonding of magnesium fluoride is preferable.

In the surface portion, for example, the concentrations of magnesium and aluminum measured by XPS or the like are preferably higher than the concentrations measured by ICP-MS (inductively coupled plasma mass spectrometry), GD-MS (glow discharge mass spectrometry), or the like.

When a cross section is exposed by processing and analyzed by TEM-EDX, the concentrations of magnesium and aluminum in the surface portion are preferably higher than those in the inner portion. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

Nickel, which is one of the transition metals, may be distributed in the whole particle without being unevenly distributed in the surface portion. Note that one embodiment of the present invention is not limited thereto in the case where the above-described region where the excess additives are unevenly distributed exists.

### <Particle Diameter>

For example, the diameter of a perfect circle having an area equal to the area of the observed cross section of a particle can be regarded as the particle diameter. The observation of the cross section of a particle can be performed with a microscope, for example. As the microscope, an electron microscope such as a SEM or a TEM can be used, for example. Furthermore, the cross section is preferably exposed by processing at the time of observation. As a processing method, an FIB method, an ion polishing method, or the like can be used.

Alternatively, for example, the diameter of a perfect circle having an area equal to the area of a particle in an observation image of the particle surface can be regarded as the particle diameter.

Alternatively, for example, the particle diameter can be evaluated using values such as the particle diameter (50%D: D50, or also referred to as a median diameter), 10%D (D10), and 90%D (D90), which are obtained with a particle size distribution analyzer using a laser diffraction and scattering method. Instead of the median diameter, the average particle diameter may be used.

Alternatively, for example, the particle diameter can be evaluated using the specific surface area. The specific surface area can be measured by a gas adsorption method, for example.

### <Particle Diameter of Crystal>

A particle includes one or more crystal grains, for example. For example, the diameter of a perfect circle having an area equal to a cross-sectional area of a crystal grain observed in observation of the cross section of a particle can be regarded as the particle diameter of the crystal.

Alternatively, for example, the particle diameter of a crystal can be evaluated using a half width of an X-ray diffraction spectrum.

The electrode of one embodiment of the present invention can be formed by mixing a first particle group, a second particle group, a third particle group, and a graphene compound. The median diameters of the first particle group, the second particle group, and the third particle group are referred to as Dm1, Dm2, and Dm3, respectively. Particles belonging to the first particle group, particles belonging to the second particle group, and particles belonging to the third particle group each include a lithium composite oxide. Note that a particle group refers to a group of a plurality of particles, and particles included in a particle group are not necessarily adjacent to each other. A particle group is a group of particles belonging to the same group when particles are grouped by particle diameter. In some cases, particles belonging to different particle groups have the same particle diameter. The group of particles forming a secondary particle does not correspond to the particle group described in this specification and the like, for example.

The above description of the first particle can be applied to particles included in the first particle group. The above description of the second particle can be applied to particles included in the second particle group. The above description of the third particle can be applied to particles included in the third particle group.

Dm1 is preferably greater than or equal to 15 µm, Dm3 is preferably less than or equal to 10 µm, and Dm2 is preferably less than Dm1 and greater than Dm3.

Alternatively, Dm1 is preferably greater than or equal to 20 µm, Dm3 is preferably greater than or equal to 50 nm and less than or equal to 8 µm and further preferably greater than or equal to 100 nm and less than or equal to 7 µm, and Dm2 is preferably greater than or equal to 9 µm and less than or equal to 25 µm and smaller than Dm1.

Alternatively, Dm1 is preferably greater than or equal to 20 µm, Dm3 is preferably greater than or equal to 50 nm and less than or equal to 8 µm and further preferably greater than or equal to 100 nm and less than or equal to 7 µm, and Dm2 is preferably greater than 8 µm and less than 20 µm and further preferably greater than 7 µm and less than 20 µm.

Note that the electrode of one embodiment of the present invention may include four or more kinds of particles with different particle diameters.

In the XPS analysis performed on the first particle group and the second particle group, when the concentration of the element M is assumed to be 1, the relative value of the concentration of magnesium is preferably greater than or equal to 0.1 and less than or equal to 1.5. Furthermore, the relative value of the concentration of halogen such as fluorine is preferably greater than or equal to 0.1 and less than or equal to 1.5. When the concentration of the element M is assumed to be 1, the relative value of the concentration of magnesium in the second particle group is preferably lower than that in the first particle group. When the concentration of the element M is assumed to be 1, the relative value of the concentration of halogen such as fluorine in the second particle group is preferably lower than that in the first particle group.

In the XPS analysis performed on the third particle group, when the concentration of the element M is assumed to be 1, the relative value of the concentration of magnesium is less than or equal to 1.5 or less than 1.00, for example. When the concentration of the element M is assumed to be 1, the relative value of the concentration of magnesium in the third particle group is preferably lower than that in the second particle group. In some cases, the third particle group does not include magnesium.

In addition, when the first particle group, the second particle group, and the third particle group are analyzed with XPS, a peak indicating the bonding energy of fluorine with another element is preferably higher than or equal to 682 eV and lower than 685 eV, further preferably approximately 684.3 eV. This bonding energy is different from that of lithium fluoride (685 eV) and that of magnesium fluoride (686 eV). That is, when the first particle group, the second particle group, and the third particle group include fluorine, bonding other than bonding of lithium fluoride and magnesium fluoride is preferable.

Furthermore, when the first particle group, the second particle group, and the third particle group are analyzed by XPS, a peak indicating the bonding energy of magnesium with another element is preferably higher than or equal to 1302 eV and lower than 1304 eV, further preferably approximately 1303 eV. This bonding energy is different from that of magnesium fluoride (1305 eV) and is close to that of magnesium oxide. That is, when the first particle group, the second particle group, and the third particle group include magnesium, bonding other than bonding of magnesium fluoride is preferable.

### <Graphene Compound>

As the graphene compound, graphene in which carbon atoms in a sheet plane are terminated by an atom other than carbon or a functional group is preferably used, for example.

Graphene has a structure with its edge terminated by hydrogen. A graphene sheet has a two-dimensional structure formed of six-membered rings of carbon, and when a defect or a vacancy is generated in the two-dimensional structure, a carbon atom in the neighborhood of the defect and a carbon atom forming the vacancy is terminated by various functional groups or atoms such as hydrogen atoms or fluorine atoms, in some cases.

In a graphene compound of one embodiment of the present invention, one or both of a defect and a vacancy is formed in graphene, and one or more of a carbon atom in the neighborhood of the defect and a carbon atom forming the vacancy are terminated by a hydrogen atom, a fluorine atom, a functional group including one or more of a hydrogen atom and a fluorine atom, a functional group including oxygen, or the like, whereby the graphene compound can cling to particles included in the first particle group, particles included in the second particle group, and/or particles included in the third particle group.

The vacancy included in the graphene compound of one embodiment of the present invention is, for example, formed of a many-membered ring which is a seven- or more-membered ring of carbon or a nine- or more-membered ring of carbon.

The many-membered ring included in the graphene compound of one embodiment of the present invention is observed in a high-resolution TEM image, in some cases.

By using the graphene compound of one embodiment of the present invention, the adhesiveness between the graphene compound and the lithium composite oxide particles is increased, and the collapse of the particles in the electrode or the like can be suppressed. Furthermore, the graphene compound preferably cling to the particles. The graphene compound preferably overlays at least a portion of the active material particles. The shape of the graphene compound preferably conforms to at least a portion of the shape of the active material particles. The shape of the active material particles means, for example, an uneven surface of a single active material particle or an uneven surface formed by a plurality of active material particles. The graphene compound preferably surrounds at least a portion of the active material particles. The graphene compound may have a vacancy. When the graphene compound is in the above-described state, generation of a crack in the particles may be inhibited, for example.

The graphene compound can function as a conductive material in the electrode, enabling a highly conductive electrode.

When a plurality of graphene compounds are bonded to each other, a net-like graphene compound sheet (hereinafter referred to as a graphene compound net or a graphene net) can be formed. The graphene net covering the particles can function as a binder for bonding active materials. Accordingly, the amount of the binder can be reduced, or the binder does not have to be used. This can increase the proportion of the active material in the electrode volume and the electrode weight. That is, the charge and discharge capacity of the secondary battery can be increased.

Examples of the functional group including oxygen include a hydroxy group, an epoxy group, and a carboxy group. Note that the defect and the vacancy formed in graphene preferably exist in an amount that does not significantly impair the conductivity of the whole graphene. Here, the atom forming the vacancy indicates an atom in a periphery of an opening, an atom in an edge portion of an opening, or the like, for example.

The graphene compound of one embodiment of the present invention includes a vacancy and is formed of a plurality of carbon atoms bonded in a ring shape, an atom or a functional group which terminates the plurality of carbon atoms, and the like. A Group 13 element such as boron, a Group 15 element such as nitrogen, and a Group 16 element such as oxygen may substitute for one or more of the plurality of carbon atoms bonded in a ring shape.

In the graphene compound of one embodiment of the present invention, carbon atoms except carbon atoms in the edge are preferably terminated by a hydrogen atom, a fluorine atom, a functional group including one or more of a hydrogen atom and a fluorine atom, a functional group including oxygen, or the like. In the graphene compound of one embodiment of the present invention, for example, carbon atoms in the neighborhood of the center of a graphene plane are preferably terminated by one or more selected from a hydrogen atom, a fluorine atom, a functional group including one or more of a hydrogen atom and a fluorine atom, a functional group including oxygen, and the like.

The length of one side (also referred to as a flake size) of the graphene compound is greater than or equal to 50 nm and less than or equal to 100 µm, or greater than or equal to 800 nm and less than or equal to 50 µm.

The flake size of the graphene compound is preferably greater than the above-described Dm3, for example. With the flake size of the graphene compound being greater than the above-described Dm3, at least part of one of the particles belonging to the third particle group can be covered. Furthermore, with the flake size of the graphene compound being greater than the above-described Dm3, the graphene compound can bridge and cling to a plurality of particles belonging to the third particle group, which prevents aggregation of the plurality of particles and allows the graphene compound and the plurality of particles to disperse from each other.

### [Example of Method for Forming Electrode]

An example of a method for forming an electrode of one embodiment of the present invention is described.

### <Formation of Active Material>

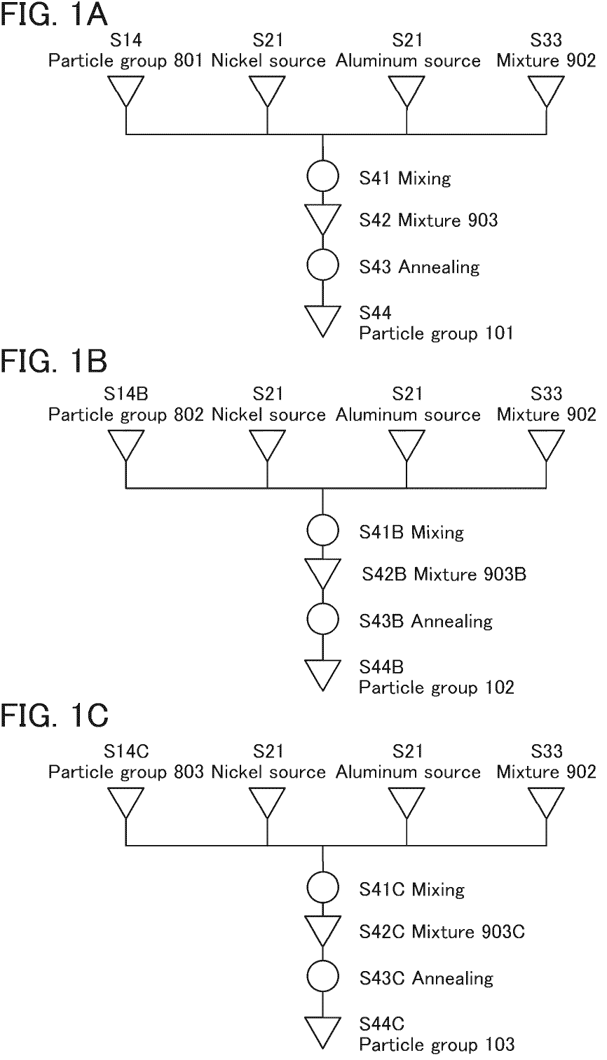

Examples of methods for forming a particle group 101, a particle group 102, and a particle group 103 each functioning as an active material are described with reference to FIG. 1.

The particle group 101, the particle group 102, and the particle group 103 are formed using a particle group 801, a particle group 802, and a particle group 803, respectively. The particle group 101 is a group of particles obtained by adding magnesium, fluorine, nickel, and aluminum to particles included in the particle group 801. The particle group 102 is a group of particles obtained by adding magnesium, fluorine, nickel, and aluminum to particles included in the particle group 802. The particle group 103 is a group of particles obtained by adding magnesium, fluorine, nickel, and aluminum to particles included in the particle group 803.

The particle group 801, the particle group 802, and the particle group 803 each include particles which are a lithium composite oxide (M is one or more metals including cobalt). The lithium composite oxide has the layered rock-salt structure, is represented by the space group R-3m, and is represented by LiMO₂.

The median diameter of the particle group 801 is greater than the median diameter of the particle group 802, and the median diameter of the particle group 802 is greater than the median diameter of the particle group 803. The median diameter of the particle group 801, the median diameter of the particle group 802, and the median diameter of the particle group 803 are referred to as Dr1, Dr2, and Dr3, respectively. Dr1 is preferably greater than or equal to 15 µm, Dr3 is preferably less than or equal to 10 µm, and Dr2 is preferably less than Dr1 and greater than Dr3. Alternatively, Dr1 is preferably greater than or equal to 20 µm, Dr3 is preferably greater than or equal to 50 nm and less than or equal to 8 µm and further preferably greater than or equal to 100 nm and less than or equal to 7 µm, and Dr2 is preferably greater than or equal to 9 µm and less than or equal to 25 µm and smaller than Dr1. Alternatively, Dr1 is preferably greater than or equal to 20 µm, Dr3 is preferably greater than or equal to 50 nm and less than or equal to 8 µm and further preferably greater than or equal to 100 nm and less than or equal to 7 µm, and Dr2 is preferably greater than 8 µm and less than 20 µm and further preferably greater than 7 µm and less than 20 µm.

FIG. 1A is a diagram illustrating the method for forming the particle group 101.

In Step S14, the particle group 801 is prepared. A method for forming the particle group 801 is described later.

Next, a nickel source is prepared in Step S21. As the nickel source, for example, nickel hydroxide can be used.

Next, an aluminum source is prepared in Step S22. As the aluminum source, for example, aluminum hydroxide, aluminum fluoride, or the like can be used.

Next, in Step S33, a mixture 902 is prepared. The mixture 902 is a mixture including magnesium and halogen. Here, for example, the mixture 902 including fluorine as the halogen is used.

Next, in Step S41, the particle group 801, the nickel source, the aluminum source, and the mixture 902 are mixed. The mixing is performed so that when the number of element M atoms included in the particle group 801 is assumed to be 100, the relative value of the number of magnesium atoms included in the mixture 902 is preferably greater than or equal to 0.1 and less than or equal to 6, and further preferably greater than or equal to 0.3 and less than or equal to 3.

The conditions of the mixing in Step S41 are preferably milder than those of the mixing in Step S32 to be described later in order not to damage the particles of the particle group 801. For example, a condition with a lower rotation frequency or shorter time than the mixing in Step S32 is preferable. In addition, it can be said that the dry process has a milder condition than the wet process. For example, a ball mill, a bead mill, or the like can be used for the mixing. When a ball mill is used, zirconia balls are preferably used as media, for example.

The materials mixed in the above step are collected to obtain a mixture 903 (Step S42).

Next, in Step S43, the mixture 903 is annealed. In this annealing step, each of the elements included in the mixture 902, the aluminum source, and the nickel source is diffused into the particles included in the particle group 801. The diffusion is faster in the surface portion and the vicinity of a grain boundary than in the inner portion of the particle. Therefore, the concentration of each of the elements in the surface portion and the vicinity of the grain boundary becomes higher than that in the inner portion.

The annealing is preferably performed at an appropriate temperature for an appropriate time. The appropriate temperature and time change depending on the conditions such as the particle size and the composition of the particles included in the particle group 801 in Step S14. In the case where the particle size is small, the annealing is preferably performed at a lower temperature or for a shorter time than annealing in the case where the particle size is large, in some cases. When the annealing is performed at too high a temperature or for too long a time, the particles are sintered in some cases.

The annealing temperature is preferably higher than or equal to 600° C. and lower than or equal to 950° C., for example. The annealing time is preferably longer than or equal to 1 hour and shorter than or equal to 10 hours, and further preferably approximately 2 hours. In this embodiment, annealing is performed at 800° C. for 2 hours.

The temperature decreasing time after the annealing is preferably longer than or equal to 10 hours and shorter than or equal to 50 hours, for example.

It is considered that when the mixture 903 is annealed, a material having a lower melting point (e.g., lithium fluoride with a melting point of 848° C.) in the mixture 902 is melted first and distributed to surface portions of the particles of the particle group 801. Next, the existence of the melted material decreases the melting points of other materials, presumably resulting in melting of the other materials. For example, magnesium fluoride (melting point: 1263° C.) is presumably melted and distributed to the surface portions of the lithium cobalt oxide particles. In other words, lithium fluoride serves as a flux.

The elements included in the mixture 902 distributed to the surface portions probably form a solid solution in the particles included in the particle group 801.

The elements included in the mixture 902 are diffused faster in the surface portions and the vicinity of the grain boundary than in the inner portions of the composite oxide particles. Thus, the concentrations of magnesium and fluorine in the surface portions and the vicinity of the grain boundary are higher than those in the inner portions.

The material heated in Step S43 is collected to obtain the particle group 101. The particle group 101 is a lithium composite oxide including the element M and includes a plurality of particles including magnesium, fluorine, aluminum, and nickel.

FIG. 1B illustrates the method for forming the particle group 102 using the particle group 802. Instead of Step S14 of preparing the particle group 801 in FIG. 1A, Step S14B of preparing the particle group 802 is conducted. The particle group 802 is mixed with the nickel source, the aluminum source, and the mixture 902 (Step S41B) to form a mixture 903B (Step S42B), and annealing is performed (Step S43B) to obtain the particle group 102 (Step S44B).

FIG. 1C illustrates the method for forming the particle group 103 using the particle group 803. Instead of Step S14 of preparing the particle group 801 in FIG. 1A, Step S14C of preparing the particle group 803 is conducted. The particle group 803 is mixed with the nickel source, the aluminum source, and the mixture 902 (Step S41C) to form a mixture 903C (Step S42C), and annealing is performed (Step S43C) to obtain the particle group 103 (Step S44C).

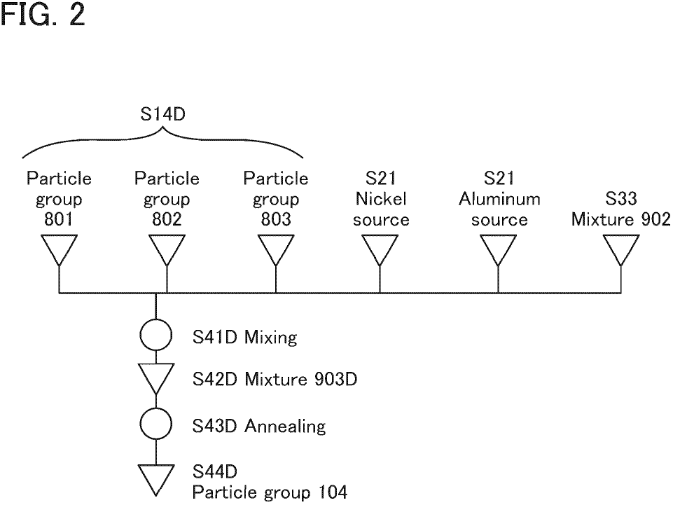

As illustrated in FIG. 2, the particle group 801, the particle group 802, and the particle group 803 may be mixed in advance before addition of magnesium, fluorine, nickel, and aluminum.

First, instead of Step S14 of preparing the particle group 801 in FIG. 1A, Step S14D of preparing the particle group 801, the particle group 802, and the particle group 803 so that the particle group 801 : the particle group 802 : the particle group 803 can be Mx1:Mx2:Mx3 (weight%) is conducted.

Mx1 is preferably greater than or equal to 5 weight% and less than or equal to 20 weight%. In the case where the thickness of the active material layer obtained in Step S96 to be described later is greater than or equal to 60 µm before pressing, Mx3 > Mx2 is preferable; in the case where the thickness thereof before pressing is less than 60 µm, Mx3 < Mx2 is preferable. Note that in the electrode of one embodiment of the present invention, the density of the electrode can be increased by using three kinds of particle groups with different median diameters. Therefore, even when pressing is not performed or the pressure of the pressing is low, an electrode with high density can be obtained. Thus, a crack of active material particles by pressing can be inhibited.

Next, the particle group 801, the particle group 802, the particle group 803, the nickel source, the aluminum source, and the mixture 902 are mixed (Step S41D) to form a mixture 903D (Step S42D), and annealing is performed (Step S43D) to obtain a particle group 104 (Step S44D).

When the steps illustrated in FIG. 2 are used, the elements such as magnesium can be added to the particle group 801, the particle group 802, and the particle group 803 at once, whereby the steps can be simplified.

Note that the particle group 801, the particle group 802, and the particle group 803 have different average particle diameters. Different average particle diameters have different ratios of surface area to volume. Since the elements added in Step S41D to Step S44D diffuse from the surfaces of the particles, the added element can be different depending on the particle group, in some cases.

Since the elements added in Step S41D to Step S44D are rapidly diffused in a grain boundary, in a particle including many grain boundaries, the added element is unevenly distributed in the grain boundaries, lowering the concentration of the added element in the surface of the particle, in some cases.

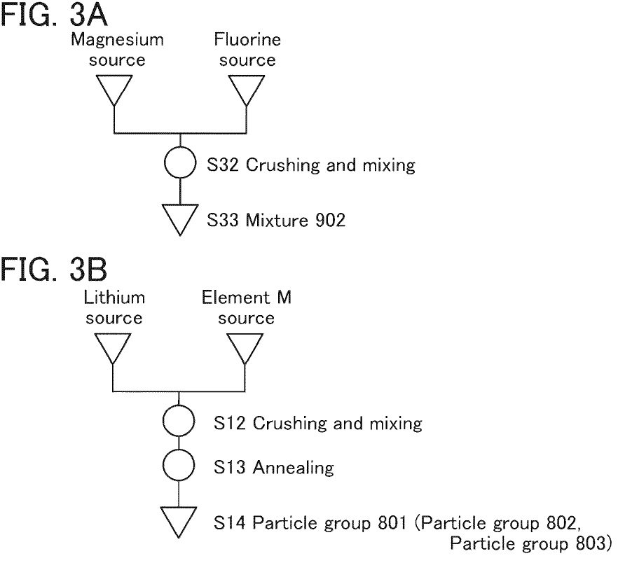

FIG. 3A illustrates a method for forming the mixture 902.

First, a magnesium source and a fluorine source are prepared. As the magnesium source, for example, magnesium fluoride, magnesium hydroxide, magnesium carbonate, or the like can be used. As the fluorine source, for example, lithium fluoride, magnesium fluoride, or the like can be used. That is, lithium fluoride can be used as both the lithium source and the fluorine source, and magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a molar ratio of approximately LiF:MgF₂ = 1:3, the effect of lowering the melting point becomes the highest. On the other hand, when the amount of lithium fluoride increases, cycle performance might deteriorate because of too large an amount of lithium. Therefore, the molar ratio of lithium fluoride LiF to magnesium fluoride MgF₂ is preferably LiF:MgF₂ = x:1 (0 ≤ x ≤ 1.9), further preferably LiF:MgF₂ = x: 1 (0.1 ≤ x ≤ 0.5), still further preferably LiF:MgF₂ = x:1 (x = the vicinity of 0.33). Note that in this specification and the like, the vicinity means a value greater than 0.9 times and less than 1.1 times a certain value.

In this embodiment, LiF and MgF₂ are mixed at a molar ratio of LiF:MgF₂ = 1:3 and a weight ratio of LiF:MgF₂ = 12.19:87.81.

In addition, in the case where the following crushing and mixing steps are performed by a wet process, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

Next, the magnesium source and the fluorine source are crushed and mixed. Although the mixing can be performed by a dry method or a wet method, a wet method is preferable because the materials can be ground to a smaller size. For example, a ball mill, a bead mill, or the like can be used for the mixing. When a ball mill is used, zirconia balls are preferably used as media, for example. The crushing and mixing step is preferably performed sufficiently to pulverize the mixture 902.

In this embodiment, mixing and grinding are performed with a ball mill. More specifically, the magnesium source and the fluorine source are put in a ball mill container (zirconia pot manufactured by Ito Seisakusho with a capacitance of 45 mL) with a zirconia ball (1 mmφ), 20 mL of dehydrated acetone is added thereto, and crushing and mixing are performed at 400 rpm for 12 hours.

The materials crushed and mixed in Step S32 are collected to obtain the mixture 902.

In this embodiment, after Step S32 is finished, the zirconia ball and a suspension are classified using a sieve, and the suspension is dried on a hot plate at 50° C. for approximately 1 to 2 hours, whereby the mixture 902 is obtained.

When the particle size distribution of the mixture 902 is measured by, for example, a laser diffraction and scattering method, 50%D is preferably longer than or equal to 600 nm and shorter than or equal to 20 µm, further preferably longer than or equal to 1 µm and shorter than or equal to 10 µm, and still further preferably approximately 3.5 µm.When mixed with the particle group 801 in a later step, the mixture 902 pulverized to such a small size is easily attached to surfaces of the particles of the particle group 801 uniformly. The mixture 902 is preferably attached to the surfaces of the particles of the particle group 801 uniformly because both halogen and magnesium are easily distributed to the surface portion of the particle group 801 after heating.

FIG. 3B illustrates methods for forming the particle group 801, the particle group 802, and the particle group 803.

An example of the formation method is described with reference to FIG. 3B. First, a lithium source and an element M source are prepared as starting materials. The element M is one or more metals including cobalt. As the element M, cobalt can be used. As the element M, cobalt and one or more selected from nickel, manganese, and aluminum can be used.

As the lithium source, for example, lithium carbonate or lithium fluoride can be used. As the element M source, an oxide of a metal, a hydroxide of a metal, or the like can be used. Specifically, cobalt oxide, cobalt hydroxide, manganese oxide, manganese hydroxide, nickel oxide, nickel hydroxide, aluminum oxide, aluminum hydroxide, or the like can be used, for example. Note that the impurity concentration of the starting materials is higher than or equal to 3 N (99.9 %), preferably higher than or equal to 4 N (99.99 %), further preferably higher than or equal to 4N5 (99.995 %), and further preferably higher than or equal to 5 N (99.999 %).

Next, the above-described starting raw materials are mixed. For example, a ball mill, a bead mill, or the like can be used for the mixing. When the ball mill is used, a zirconia ball can be used as media, for example.

The particle diameter of the mixed material affects the particle diameter of the material after baking, the particle diameter of crystal grains, and the like. Therefore, in this step, for example, using a ball mill with an orbital radius of 75 mm and a spinning vessel radius of 20 mm, processing at 400 rpm for 2 hours and processing at greater than or equal to 100 rpm and less than or equal to 300 rpm for 12 hours are preferably performed to form the particle group 801 and the particle group 803, respectively.

Next, the mixed material is annealed in Step S13. The annealing is preferably performed at higher than or equal to 800° C. and lower than 1100° C., further preferably at higher than or equal to 900° C. and lower than or equal to 1000° C., still further preferably at approximately 950° C. Excessively low temperature might result in insufficient decomposition and melting of the starting materials. In contrast, excessively high temperature might cause reduction of Co, evaporation of Li, and the like, leading to a defect in which Co has a valence of two.

The heating time is preferably longer than or equal to 2 hours and shorter than or equal to 20 hours. The baking is preferably performed in an atmosphere such as dry air. For example, it is preferable that the heating be performed at 950° C. for 10 hours, the temperature rise be 200° C./h, and the flow rate of a dry atmosphere be 10 L/min. After that, the heated material is cooled to room temperature. The temperature decreasing time from the holding temperature to room temperature is preferably longer than or equal to 10 hours and shorter than or equal to 50 hours, for example.

The material annealed in Step S13 is collected to obtain the particle group 801. The particle group 801 is a lithium composite oxide including the element M.

The particle group 802 and the particle group 803 can also be formed through the steps illustrated in FIG. 3B. Here, the median diameter of the particle group 802 is preferably smaller than the median diameter of the particle group 801, and the median diameter of the particle group 803 is preferably smaller than the median diameter of the particle group 802.

For example, when the particle diameters of the starting materials, specifically, those of the lithium source and/or the element M source are made small, the median diameter of particles obtained in Step S14 can be small, in some cases. For example, by crushing the starting materials with a ball mill, the particles obtained in Step S14 can have a small median diameter, in some cases.

Furthermore, by changing the ratio between the lithium source and the element M source, the median diameter of the particles obtained in Step S14 can be changed, in some cases. For example, in the case of forming the particle group 803, assuming that the number of moles of the element M included in the element M source is 1, the number of moles of lithium included in the lithium source is set to be greater than or equal to 1 and less than 1.05. Furthermore, for example, in the case of forming the particle group 801, assuming that the number of moles of the element M included in the element M source is 1, the number of moles of lithium included in the lithium source is set to be greater than or equal to 1.05, preferably greater than or equal to 1.065.

Moreover, when the annealing temperature in Step S13 is low and/or when the annealing time in Step S13 is short, the particles obtained in Step S14 can have a small median diameter, in some cases.

In forming a lithium composite oxide, a method different from that of FIG. 3B, such as a coprecipitation method, may be used, for example.

### <Formation of Electrode>

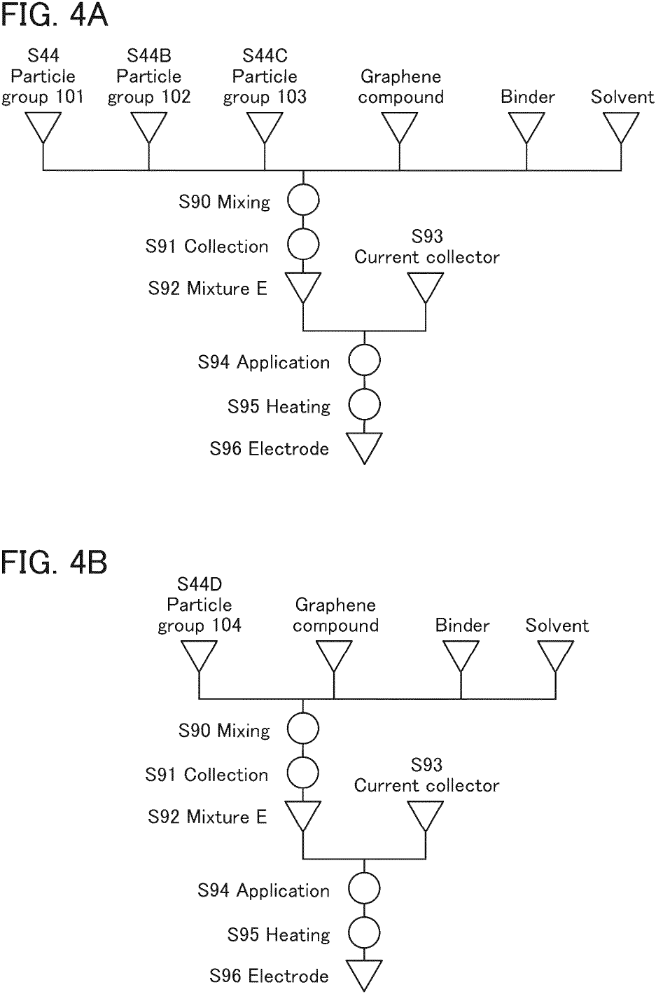

Next, methods for forming an electrode are described with reference to FIG. 4.

FIG. 4A illustrates an example of a method for forming an electrode using the particle group 101, the particle group 102, and the particle group 103.

First, the particle group 101, the particle group 102, the particle group 103, the graphene compound, a binder, and a solvent are prepared.

As the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Polyimide has extremely excellent thermal, mechanical, and chemical stability.

A fluorine polymer which is a high molecular material containing fluorine, specifically, polyvinylidene fluoride (PVDF) can be used, for example. PVDF is a resin having a melting point in the range of higher than or equal to 134° C. and lower than or equal to 169° C., and is a material with excellent thermal stability.

As the binder, a rubber material such as styrene-butadiene rubber (SBR), styreneisoprene-styrene rubber, acrylonitrile-butadiene rubber, butadiene rubber, or an ethylene-propylene-diene copolymer is preferably used. Alternatively, fluororubber can be used as the binder.

As the binder, for example, water-soluble polymers are preferably used. As the water-soluble polymers, a polysaccharide or the like can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferred that such water-soluble polymers be used in combination with any of the above-described rubber materials.

Two or more of the above-described materials may be used in combination for the binder.

As the conductive material, a graphene compound can be used. In addition to the graphene compound, natural graphite, artificial graphite such as mesocarbon microbeads, carbon fiber, or the like can be used as the conductive material. As carbon fiber, mesophase pitch-based carbon fiber, isotropic pitch-based carbon fiber, or the like can be used, for example. Other examples of carbon fiber include carbon nanofiber and carbon nanotube. Carbon nanotube can be formed by, for example, a vapor deposition method. Other examples of the conductive additive include carbon materials such as carbon black (e.g., acetylene black (AB)), graphite (black lead) particles, and fullerene. Alternatively, metal powder or metal fibers of copper, nickel, aluminum, silver, gold, or the like, a conductive ceramic material, or the like can be used.

As a solvent, any one of N-methylpyrrolidone (NMP), water, methanol, ethanol, acetone, tetrahydrofuran (THF), dimethylformamide (DMF), and dimethyl sulfoxide (DMSO), or a mixed solution of two or more of the above can be used.

Next, in Step S90, the particle group 101, the particle group 102, the particle group 103, the graphene compound, the binder, and the solvent are mixed. Note that the mixing may be performed in stages; for example, after mixing some of the prepared materials, the remaining materials may be added and mixed. The solvent may be added in several batches without being added at once.

The particle group 101, the particle group 102, and the particle group 103 are prepared so that the particle group 101 : the particle group 102 : the particle group 103 can be Mx1:Mx2:Mx3 (weight%). The sum of Mx1, Mx2, and Mx3 is assumed to be 100. Mx3 is preferably greater than or equal to 5 weight% and less than or equal to 20 weight%. In the case where the thickness of the active material layer obtained in Step S96 is greater than or equal to 60 µm before pressing, Mx1 > Mx2 is preferable; in the case where the thickness thereof before pressing is less than 60 µm, Mx1 < Mx2 is preferable.

Next, the mixture is collected (Step S91) to obtain a mixture E (Step S92).

Next, a current collector is prepared in Step S93.

Next, in Step S94, the mixture E is applied onto the current collector.

Next, heating is performed to volatilize the solvent (Step S95), so that an electrode in which an active material layer is formed over the current collector is obtained (Step S96). After the heating, pressing may be performed to increase the density of the active material layer.

FIG. 4B illustrates an example of forming an electrode using the particle group 104 instead of using the particle group 101, the particle group 102, and the particle group 103.

### <Example of Electrode>

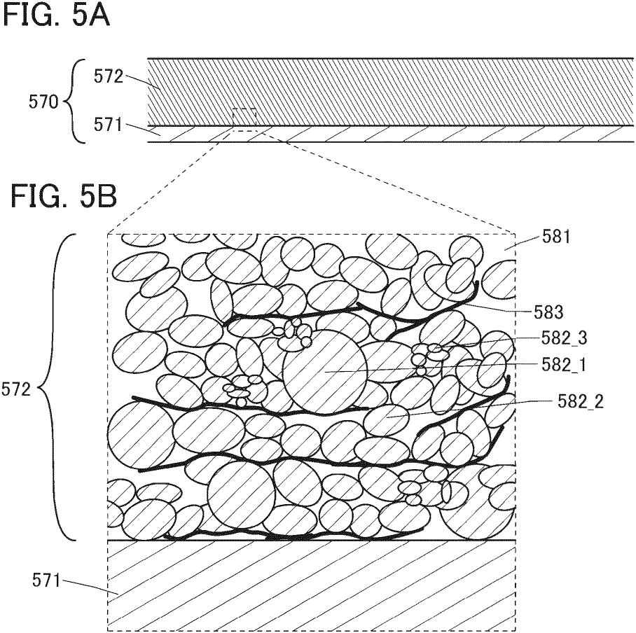

FIG. 5A is a schematic cross-sectional view of an electrode of one embodiment of the present invention. An electrode 570 illustrated in FIG. 5A can be used as a positive electrode and a negative electrode included in a secondary battery. The electrode 570 includes at least a current collector 571 and an active material layer 572 formed in contact with the current collector 571.

FIG. 5B is an enlarged view of a region surrounded by a dashed line in FIG. 5A. As illustrated in FIG. 5B, the active material layer 572 includes an electrolyte 581, an active material 582_1, an active material 582_2, and an active material 582_3. As the active material 582_1, particles belonging to the above-described particle group 101 can be used. As the active material 582_2, particles belonging to the above-described particle group 102 can be used. As the active material 582_3, particles belonging to the above-described particle group 103 can be used.

The active material layer 572 preferably includes a conductive material. FIG. 5B illustrates an example in which the active material layer 572 includes a graphene compound 583.

The active material layer 572 preferably includes a binder (not illustrated). The binder binds or fixes the electrolyte and the active materials, for example. In addition, the binder can bind or fix the electrolyte and a carbon-based material, the active material and a carbon-based material, a plurality of active materials, a plurality of carbon-based materials, or the like.

The graphene compound 583 can cling to the active materials 582 like fermented soybeans. For example, the active materials 582 and the graphene compound 583 can be compared to soybeans and a sticky ingredient, respectively. By providing the graphene compound 583 as a bridge between materials included in the active material layer 572, such as the electrolyte, the plurality of active materials, and the plurality of carbon-based materials, it is possible to not only form an excellent conductive path in the active material layer 572 but also bind or fix the materials with use of the graphene compound 583. In addition, for example, a three-dimensional net-like structure is formed using a plurality of graphene compounds 583 and materials such as the electrolyte, the plurality of active materials, and the plurality of carbon-based materials are placed in meshes, whereby the graphene compounds 583 form a three-dimensional conductive path and detachment of an electrolyte from the current collector can be suppressed. Thus, in the active material layer 572, the graphene compound 583 functions as a conductive material and may also function as a binder.

The active materials 582 can have any of various shapes such as a rounded shape and an angular shape. In addition, on the cross section of the electrode, the active materials 582 can have any of various cross-sectional shapes such as a circle, an ellipse, a shape having a curved line, and a polygon. For example, FIG. 5B illustrates an example in which the cross sections of the active materials 582 have a rounded shape as an example; however, the cross sections of the active materials 582 may be angular. Alternatively, one part may be rounded and another part may be angular.

An example of a positive electrode active material that can be used as the particles (the first particle, the second particle, and the third particle) of one embodiment of the present invention is described below.

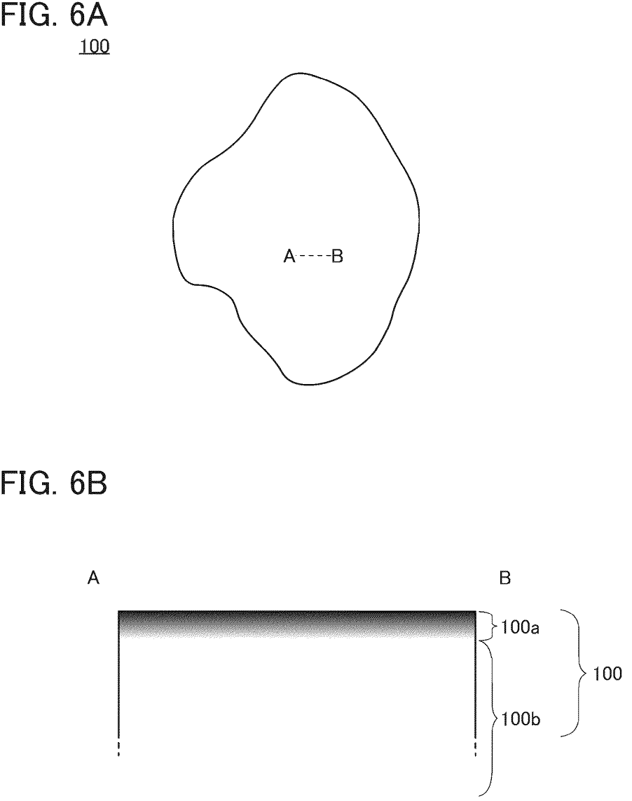

FIG. 6A is a schematic top view of a positive electrode active material 100 which is one embodiment of the present invention. FIG. 6B is a schematic cross-sectional view taken along A-B in FIG. 6A.

### <Included Elements and Distribution>

The positive electrode active material 100 includes lithium, a transition metal, oxygen, and an additive. The positive electrode active material 100 can be regarded as a composite oxide represented by LiMO₂ to which an additive is added.

As the transition metal included in the positive electrode active material 100, a metal that can form, together with lithium, a composite oxide having the layered rock-salt structure belonging to the space group R-3m is preferably used. For example, at least one of manganese, cobalt, and nickel can be used. That is, as the transition metal included in the positive electrode active material 100, cobalt may be used alone, nickel may be used alone, cobalt and manganese may be used, cobalt and nickel may be used, or cobalt, manganese, and nickel may be used. In other words, the positive electrode active material 100 can contain a composite oxide containing lithium and the transition metal, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. Nickel is preferably contained as the transition metal in addition to cobalt, in which case a crystal structure may be more stable in a state where charging with high voltage is performed and a large amount of lithium is extracted.

As an added element X included in the positive electrode active material 100, one or more elements selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. These elements further stabilize a crystal structure included in the positive electrode active material 100 in some cases, as described later. The positive electrode active material 100 can include lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. In this specification and the like, the added element X may be rephrased as a constituent of a mixture or a raw material or the like.

As illustrated in FIG. 6B, the positive electrode active material 100 includes a surface portion 100a and an inner portion 100b. The surface portion 100a preferably has a higher concentration of an additive than the inner portion 100b. The concentration of the additive preferably has a gradient as shown in FIG. 6B by gradation, in which the concentration increases from the inner portion toward the surface. In this specification and the like, the surface portion 100a refers to a region from a surface to a depth of approximately 10 nm in the positive electrode active material 100. A plane generated by a split and/or a crack may also be referred to as a surface. A region which is deeper than the surface portion 100a of the positive electrode active material 100 is referred to as the inner portion 100b.

In order to prevent the breakage of a layered structure formed of octahedrons of cobalt and oxygen even when lithium is extracted from the positive electrode active material 100 of one embodiment of the present invention by charging, the surface portion 100a having a high concentration of the additive, i.e., the outer portion of a particle, is reinforced.

The concentration gradient of the additive preferably exists uniformly in the entire surface portion 100a of the positive electrode active material 100. A situation where only part of the surface portion 100a has reinforcement is not preferable because stress might be concentrated on parts that do not have reinforcement. The concentration of stress on part of a particle might cause defects such as cracks from that part, leading to breakage of the positive electrode active material and a decrease in charge and discharge capacity.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charging and discharging, and is thus preferable. However, excess magnesium might adversely affect insertion and extraction of lithium.

Aluminum is trivalent and can exist at a transition metal site in the layered rock-salt crystal structure. Aluminum can inhibit dissolution of surrounding cobalt. The bonding strength of aluminum with oxygen is high, thereby inhibiting extraction of oxygen around aluminum. Hence, aluminum included as the additive enables the positive electrode active material 100 to have the crystal structure that is unlikely to be broken by repetitive charging and discharging.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not including fluorine and divalent to trivalent in the case of including fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including an oxide of titanium in the surface portion 100a presumably has good wettability with respect to a high-polarity solvent. Such the positive electrode active material 100 and a high-polarity electrolyte solution can have favorable contact at the interface therebetween and presumably inhibit a resistance increase when a secondary battery is formed using the positive electrode active material 100. In this specification and the like, an electrolyte solution may be read as an electrolyte.

The voltage of a positive electrode generally increases with increasing charge voltage of a secondary battery. The positive electrode active material of one embodiment of the present invention has a stable crystal structure even at high voltage. The stable crystal structure of the positive electrode active material in a charged state can suppress a capacity decrease due to repetitive charging and discharging.

A short circuit of a secondary battery might cause not only malfunction in charge operation and/or discharge operation of the secondary battery but also heat generation and firing. In order to obtain a safe secondary battery, a short-circuit current is preferably inhibited even at high charge voltage. In the positive electrode active material 100 of one embodiment of the present invention, a short-circuit current is inhibited even at high charge voltage. Thus, a secondary battery with high capacity and safety can be obtained.

It is preferable that a secondary battery using the positive electrode active material 100 of one embodiment of the present invention have high capacity, excellent charge and discharge cycle performance, and safety simultaneously.

The gradient of the concentration of the additive can be evaluated using energy dispersive X-ray spectroscopy (EDX). In the EDX measurement, to measure a region while scanning the region and evaluate the region two-dimensionally is referred to as EDX planar analysis in some cases. In addition, to extract data of a linear region from EDX planar analysis and evaluate the atomic concentration distribution in a positive electrode active material particle is referred to as linear analysis in some cases.

By EDX surface analysis (e.g., element mapping), the concentrations of the additive in the surface portion 100a, the inner portion 100b, the vicinity of the crystal grain boundary, and the like of the positive electrode active material 100 can be quantitatively analyzed. By EDX linear analysis, the concentration peak of the additive can be analyzed.

When the positive electrode active material 100 is analyzed with the EDX linear analysis, a peak of the magnesium concentration in the surface portion 100a preferably exists in a region from the surface of the positive electrode active material 100 to a depth of 3 nm toward the center, further preferably to a depth of 1 nm, still further preferably to a depth of 0.5 nm.

In addition, the distribution of fluorine contained in the positive electrode active material 100 preferably overlaps with the distribution of magnesium. Thus, when the EDX linear analysis is performed, a peak of the fluorine concentration in the surface portion 100a preferably exists in a region from the surface of the positive electrode active material 100 to a depth of 3 nm toward the center, further preferably to a depth of 1 nm, still further preferably to a depth of 0.5 nm.

Note that the concentration distribution may differ between additives. For example, in the case where the positive electrode active material 100 includes aluminum as the additive, the distribution of aluminum is preferably slightly different from that of magnesium and that of fluorine. For example, in the EDX linear analysis, the peak of the magnesium concentration is preferably closer to the surface than the peak of the aluminum concentration is in the surface portion 100a. For example, the peak of the aluminum concentration is preferably present in a region from the surface of the positive electrode active material 100 to a depth of 0.5 nm or more and 20 nm or less toward the center, further preferably to a depth of 1 nm or more and 5 nm or less.

When the linear analysis or the surface analysis is performed on the positive electrode active material 100, the ratio (I/M) between an additive I and the transition metal M in the vicinity of the crystal grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20. For example, when the additive is magnesium and the transition metal is cobalt, the atomic ratio (Mg/Co) between magnesium and cobalt is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

As described above, excess additives in the positive electrode active material 100 might adversely affect insertion and extraction of lithium. The use of such a positive electrode active material 100 for a secondary battery might cause a resistance increase, a capacity decrease, and the like. Meanwhile, when the amount of additive is insufficient, the additive is not distributed over the whole surface portion 100a, which might reduce the effect of maintaining the crystal structure. The additive at an appropriate concentration is required in the positive electrode active material 100; however, the adjustment of the concentration is not easy.

For this reason, the positive electrode active material 100 may include a region where excess additives are unevenly distributed, for example. With such a region, the excess additive is removed from the other region, and the additive concentration in most of the inner portion and the vicinity of the surface in the positive electrode active material 100 can be appropriate. An appropriate additive concentration in most of the inner portion and the vicinity of the surface in the positive electrode active material 100 can inhibit a resistance increase, a capacity decrease, and the like when the positive electrode active material 100 is used for a secondary battery. A feature of inhibiting a resistance increase of a secondary battery is extremely preferable especially in charging and discharging at a high rate.

In the positive electrode active material 100 including the region where the excess additive is unevenly distributed, mixing of an excess additive to some extent in the formation process is acceptable. This is preferable because the margin of production can be increased.

Note that in this specification and the like, uneven distribution means that the concentration of an element in a certain region differs from another region. It may be rephrased as segregation, precipitation, unevenness, deviation, high concentration, low concentration, or the like.

### <Crystal Structure>

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiMO₂ is given.

It is known that the Jahn-Teller effect in a transition metal compound varies in degree according to the number of electrons in the d orbital of the transition metal.

In a compound including nickel, distortion is likely to be caused because of the Jahn-Teller effect in some cases. Accordingly, when charging and discharging with high voltage are performed on LiNiO₂, in the case where the amount of lithium inserted and extracted is large, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

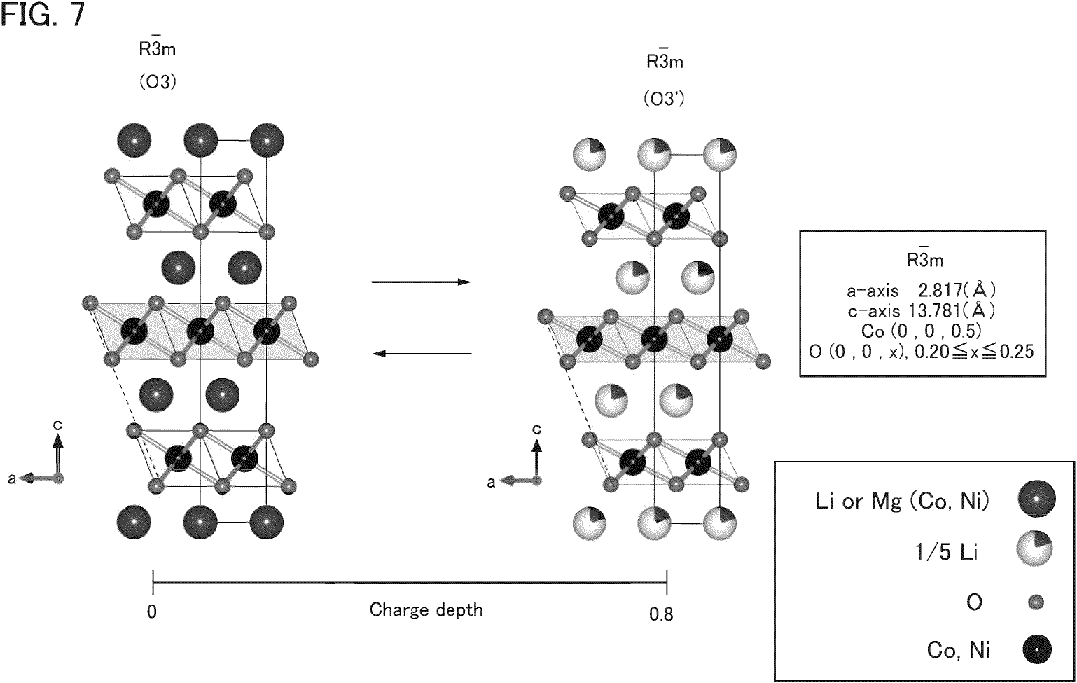

Positive electrode active materials are described with reference to FIG. 7 to FIG. 10. In FIG. 7 to FIG. 10, the case where cobalt is used as the transition metal included in the positive electrode active material is described.

### <Conventional Positive Electrode Active Material>

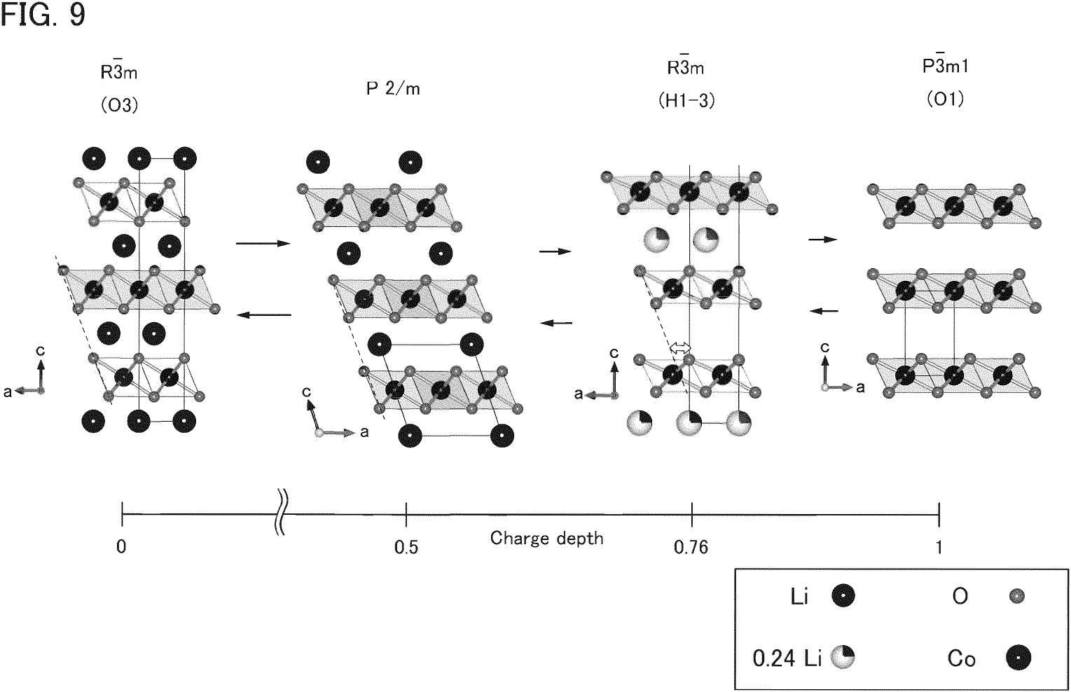

A positive electrode active material shown in FIG. 9 is lithium cobalt oxide (LiCoO₂) to which halogen and magnesium are not added in a formation method described later. As described in Non-Patent Document 1, Non-Patent Document 2, and the like, the crystal structure of the lithium cobalt oxide shown in FIG. 9 changes with the charge depth.

As illustrated in FIG. 9, lithium cobalt oxide with a charge depth of 0 (discharged state) includes a region having a crystal structure belonging to the space group R-3m and includes three CoO₂ layers in a unit cell. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3m1 and includes one CoO₂ layer in a unit cell. Hence, this crystal structure is referred to as an O1 type crystal structure in some cases.

Lithium cobalt oxide with a charge depth of approximately 0.88 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 9, and other drawings, the c-axis of the H1-3 type crystal structure is half that of the unit cell for easy comparison with the other structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ crystal structure and the H1-3 type structure, and the amount of change from the O3 structure is smaller in the O3′ crystal structure than in the H1-3 type structure. A preferred unit cell for representing a crystal structure in a positive electrode active material is selected such that the value of goodness of fit (GOF) is smaller in Rietveld analysis of XRD, for example.

When charging at a high charge voltage of 4.6 V or more with reference to the redox potential of a lithium metal or charging with a large depth with x in LiₓCoO₂ being 0.24 or less and discharging are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the arrow in FIG. 9, the CoO₂ layer in the H1-3 type crystal structure largely shifts from R-3m (O3). Such a dynamic structural change can adversely affect the stability of the crystal structure.

A difference in volume is also large. The H1-3 type crystal structure and the O3 type crystal structure in a discharged state that contain the same number of cobalt atoms have a difference in volume of more than or equal to 3.0%, or more than 3.5%, and typically more than or equal to 3.9%.

In addition, a structure in which CoO₂ layers are arranged continuously, such as P-3m1 (O1), included in the H1-3 type crystal structure is highly likely to be unstable.

Accordingly, the repeated charging and discharging with high voltage and a large charge depth gradually break the crystal structure of lithium cobalt oxide. The broken crystal structure triggers deterioration of the cycle performance. This is because the broken crystal structure has a smaller number of sites where lithium can exist stably and makes it difficult to insert and extract lithium.

### <Positive Electrode Active Material of One Embodiment of the Present Invention>

### <<Inner Portion>>

In the positive electrode active material 100 of one embodiment of the present invention, the shift in CoO₂ layers can be small in repeated charging and discharging with high voltage and a large charge depth. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high voltage charged state. Thus, in the positive electrode active material of one embodiment of the present invention, a short circuit is unlikely to occur while the high voltage charged state is maintained, in some cases. This is preferable because the safety is further improved.

The positive electrode active material of one embodiment of the present invention has a small crystal-structure change and a small volume difference per the same number of atoms of the transition metal between a sufficiently discharged state and a high voltage charged state.

FIG. 7 shows a crystal structure of the positive electrode active material 100 before and after charging and discharging. The positive electrode active material 100 is a composite oxide containing lithium, cobalt as the transition metal, and oxygen. In addition to the above-described elements, magnesium is preferably contained as the additive. Furthermore, halogen such as fluorine or chlorine is preferably contained as the additive.

The crystal structure with a charge depth of 0 (discharged state) in FIG. 7 is R-3m (O3), which is the same as in FIG. 9. Meanwhile, the positive electrode active material 100 with a charge depth in a sufficiently charged state includes a crystal whose structure is different from the H1-3 type crystal structure. This structure belongs to the space group R-3m and is not the spinel crystal structure but has symmetry in cation arrangement similar to that of the spinel structure because an ion of cobalt, magnesium, or the like occupies a site coordinated to six oxygen atoms. Furthermore, the periodicity of CoO₂ layers of this structure is the same as that in the O3 type structure. This structure is thus referred to as the O3′ type crystal structure or the pseudo-spinel crystal structure in this specification and the like. Accordingly, the O3′ type crystal structure may be rephrased as the pseudo-spinel crystal structure. Note that although the indication of lithium is omitted in the diagram of the O3′ type crystal structure shown in FIG. 7 to explain the symmetry of cobalt atoms and the symmetry of oxygen atoms, a lithium of 20 atomic% or less, for example, with respect to cobalt practically exists between the CoO₂ layers. In both the O3 type crystal structure and the O3′ type crystal structure, a slight amount of magnesium preferably exists between the CoO₂ layers, i.e., in lithium sites. In addition, a slight amount of halogen such as fluorine preferably exists at random in oxygen sites.

Note that in the O3′ type crystal structure, a light element such as lithium sometimes occupies a site coordinated to four oxygen atoms; also in this case, the ion arrangement has symmetry similar to that of the spinel structure.

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide (Li_{0.06}NiO₂) charged to a charge depth of 0.94; however, pure lithium cobalt oxide or a layered rock-salt positive electrode active material containing a large amount of cobalt is known not to have such a crystal structure generally.

In the positive electrode active material 100 of one embodiment of the present invention, a change in the crystal structure caused when a large amount of lithium is extracted by charging with high voltage and a large charge depth is smaller than that in a conventional positive electrode active material. As denoted by the dotted lines in FIG. 7, for example, the CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when charging and discharging with high voltage are repeated.

In the positive electrode active material 100, the O3 type crystal structure and the O3′ type crystal structure in a discharged state that contain the same number of cobalt atoms have a difference in volume of less than or equal to 2.5%, specifically less than or equal to 2.2 %.

Note that in the unit cell of the O3′ type crystal structure, the coordinates of cobalt and oxygen can be represented by Co (0, 0, 0.5) and O (0, 0, x) within the range of 0.20 ≤ x ≤ 0.25.

A slight amount of the additive such as magnesium randomly existing between the CoO₂ layers, i.e., in lithium sites, can suppress a shift in the CoO₂ layers. Thus, magnesium between the CoO₂ layers makes it easier to obtain the O3′ type crystal structure. Therefore, magnesium is preferably distributed throughout a particle of the positive electrode active material 100 of one embodiment of the present invention. To distribute magnesium throughout the particle, heat treatment is preferably performed in the formation process of the positive electrode active material 100 of one embodiment of the present invention.

However, heat treatment at an excessively high temperature may cause cation mixing, which increases the possibility of entry of the additive such as magnesium into the cobalt sites. Magnesium in the cobalt sites does not have the effect of maintaining the structure belonging to R-3m at the time of charging with high voltage. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium throughout the particle. The addition of the halogen compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 and less than 0.04, still further preferably approximately 0.02 the number of atoms of the transition metal. The magnesium concentration described here may be a value obtained by element analysis on the whole particles of the positive electrode active material using ICP-MS or the like, or may be a value based on the ratio of the raw materials mixed in the process of forming the positive electrode active material, for example.

As a metal other than cobalt (hereinafter, a metal Z), one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are likely to have a valence of four stably and thus contribute highly to a stable structure. The addition of the metal Z may enable the positive electrode active material of one embodiment of the present invention to have a more stable crystal structure in high-voltage charged state, for example. Here, in the positive electrode active material of one embodiment of the present invention, the metal Z is preferably added at a concentration that does not greatly change the crystallinity of the lithium cobalt oxide. For example, the metal Z is preferably added at an amount with which the aforementioned Jahn-Teller effect is not exhibited.

Aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as a metal Z in addition to magnesium, the capacity per weight and per volume can be increased in some cases. When the positive electrode active material of one embodiment of the present invention contains aluminum as the metal Z in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements contained in the positive electrode active material of one embodiment of the present invention, such as magnesium and the metal Z, are described below using the number of atoms.

The number of nickel atoms in the positive electrode active material of one embodiment of the present invention is preferably less than or equal to 10%, further preferably less than or equal to 7.5%, still further preferably greater than or equal to 0.05% and less than or equal to 4%, and especially preferably greater than or equal to 0.1% and less than or equal to 2% of the number of cobalt atoms. The nickel concentration described here may be a value obtained by element analysis on the whole particles of the positive electrode active material using ICP-MS or the like, or may be a value based on the ratio of the raw materials mixed in the process of forming the positive electrode active material, for example.

When a state being charged with high voltage is held for a long time, the transition metal dissolves in an electrolyte solution from the positive electrode active material, and the crystal structure might be broken. However, when nickel is included at the above-described proportion, dissolution of the transition metal from the positive electrode active material 100 can be inhibited in some cases.

The number of aluminum atoms in the positive electrode active material of one embodiment of the present invention is preferably greater than or equal to 0.05 % and less than or equal to 4%, further preferably greater than or equal to 0.1% and less than or equal to 2% of the number of cobalt atoms. The aluminum concentration described here may be a value obtained by element analysis on the whole particles of the positive electrode active material using ICP-MS or the like, or may be a value based on the ratio of the raw materials mixed in the process of forming the positive electrode active material, for example.

It is preferable that the positive electrode active material of one embodiment of the present invention contain an element X and phosphorus be used as the element X. The positive electrode active material of one embodiment of the present invention further preferably includes a compound containing phosphorus and oxygen.

When the positive electrode active material of one embodiment of the present invention includes a compound containing the element X, a short circuit is unlikely to occur while a high voltage charged state is maintained, in some cases.

When the positive electrode active material of one embodiment of the present invention contains phosphorus as the element X, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the charge solution may inhibit corrosion of a current collector and/or separation of a coating film or may inhibit a reduction in adhesion properties due to gelling and/or insolubilization of PVDF.

When containing magnesium in addition to the element X, the positive electrode active material of one embodiment of the present invention is extremely stable in a high voltage charged state. When the element X is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. In addition, the number of magnesium atoms is preferably greater than or equal to 0.1% and less than or equal to and 10%, further preferably greater than or equal to 0.5% and less than or equal to 5%, still further preferably greater than or equal to 0.7% and less than or equal to 4% of the number of cobalt atoms. The phosphorus concentration and the magnesium concentration described here may each be a value obtained by element analysis on the whole particles of the positive electrode active material using ICP-MS or the like, or may be a value based on the ratio of the raw materials mixed in the process of forming the positive electrode active material, for example.

In the case where the positive electrode active material has a crack, phosphorus, more specifically, a compound containing phosphorus and oxygen, in the inner portion of the positive electrode active material with the crack may inhibit crack development, for example.

The oxygen atoms indicated by arrows in FIG. 7 reveal a slight difference in the symmetry of oxygen atoms between the O3-type crystal structure and the O3′ type crystal structure. Specifically, the oxygen atoms in the O3-type crystal structure are aligned with the (110) plane, whereas strict alignment of the oxygen atoms with the (110) plane is not observed in the O3′ type crystal structure. This is caused by an increase in the amount of tetravalent cobalt along with a decrease in the amount of lithium in the O3′ type crystal structure, resulting in an increase in the Jahn-Teller distortion. Consequently, the octahedral structure of CoO2 is distorted. In addition, repelling of oxygen atoms in the CoO2 layer becomes stronger along with a decrease in the amount of lithium, which also affects the difference in symmetry of oxygen atoms.

### <<Surface Portion 100a>>

It is preferable that magnesium be distributed throughout a particle of the positive electrode active material 100 of one embodiment of the present invention, and it is further preferable that the magnesium concentration in the surface portion 100a be higher than the average magnesium concentration in the whole particle. For example, the magnesium concentration in the surface portion 100a measured by XPS or the like is preferably higher than the average magnesium concentration in the whole particle measured by ICP-MS or the like.

In the case where the positive electrode active material 100 of one embodiment of the present invention contains an element other than cobalt, for example, one or more metals selected from nickel, aluminum, manganese, iron, and chromium, the concentration of the metal in the vicinity of the surface of the particle is preferably higher than the average concentration in the whole particle. For example, the concentration of the element other than cobalt in the surface portion 100a measured by XPS or the like is preferably higher than the average concentration of the element in the whole particles measured by ICP-MS or the like.

The surface of the particle is a kind of crystal defects and lithium is extracted from the surface during charging; thus, the lithium concentration in the surface of the particle tends to be lower than that in the inner portion. Therefore, the surface tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of halogen such as fluorine in the surface portion 100a of the positive electrode active material 100 of one embodiment of the present invention is preferably higher than the average concentration in the whole particle. When halogen exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additives such as magnesium and fluorine are preferably higher than those in the inner portion. The surface portion 100a having such a composition preferably has a crystal structure stable at room temperature. Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ crystal are presumed to form a cubic close-packed structure. When these crystals are in contact with each other, there exists a crystal plane at which orientations of cubic close-packed structures formed of anions are aligned with each other. Note that the space group of the layered rock-salt crystal and the O3′ crystal is R-3m, which is different from the space group Fm-3m (the space group of a general rock-salt crystal) and the space group Fd-3m (the space group having the simplest symmetry in rock-salt crystals) of rock-salt crystals; thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a TEM (transmission electron microscope) image, a STEM (scanning transmission electron microscope) image, a HAADF-STEM (high-angle annular darkfield scanning TEM) image, an ABF-STEM (annular bright-field scanning transmission electron microscope) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in a TEM image and the like, a light element typified by oxygen or fluorine cannot be clearly observed in some cases; in such a case, alignment of orientations can be judged by arrangement of metal elements.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The element X is preferably positioned in the surface portion 100a of the particle of the positive electrode active material 100 of one embodiment of the present invention. For example, the positive electrode active material 100 of one embodiment of the present invention may be covered with the coating film containing the element X.

### <<Grain Boundary>>

The added element X included in the positive electrode active material 100 of one embodiment of the present invention may randomly exist in the inner portion at a slight concentration, but part of the added element is preferably segregated in a grain boundary.

In other words, the concentration of the added element X in the crystal grain boundary and its vicinity of the positive electrode active material 100 of one embodiment of the present invention is preferably higher than that in the other regions in the inner portion.

Like the particle surface, the crystal grain boundary is also a plane defect. Thus, the crystal grain boundary tends to be unstable and its crystal structure easily starts to change. Therefore, when the concentration of the added element X in the crystal grain boundary and its vicinity is higher, the change in the crystal structure can be inhibited more effectively.

In the case where the concentration of the added element X is high in the crystal grain boundary and its vicinity, even when a crack is generated along the crystal grain boundary of the particle of the positive electrode active material 100 of one embodiment of the present invention, the concentration of the added element X is increased in the vicinity of the surface generated by the crack. Thus, the positive electrode active material can have an increased corrosion resistance to hydrofluoric acid even after a crack is generated.

Note that in this specification and the like, the vicinity of the crystal grain boundary refers to a region of approximately 10 nm from the grain boundary.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution.

### <Analysis Method>

Whether or not a given positive electrode active material is the positive electrode active material 100 of one embodiment of the present invention, which has the O3′ type crystal structure at the time of high voltage charging, can be judged by analyzing a positive electrode charged with high voltage by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

As described above, the positive electrode active material 100 of one embodiment of the present invention features in a small change in the crystal structure between a high voltage charged state with a large charge depth that causes extraction of a large amount of lithium and a discharged state. A material in which 50 wt% or more of the crystal structure largely changes between a high voltage charged state and a discharged state is not preferable because the material cannot withstand charging and discharging with high voltage. It should be noted that the intended crystal structure is not obtained in some cases only by addition of the added element. For example, in a high voltage charged state, lithium cobalt oxide containing magnesium and fluorine has the O3′ type crystal structure at 60 wt% or more in some cases, and has the H1-3 type crystal structure at 50 wt% or more in other cases. In some cases, lithium cobalt oxide containing magnesium and fluorine may have the O3′ type crystal structure at almost 100 wt% at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

High-voltage charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive additive, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC : DEC = 3:7 (volume ratio) and vinylene carbonate (VC) at 2 wt% are mixed can be used.

As a separator, 25-µm-thick polypropylene can be used.

Stainless steel (SUS) can be used for a positive electrode can and a negative electrode can.

The coin cell fabricated with the above conditions is subjected to constant current charging at 4.6 V and 0.5 C and then constant voltage charging until the current value reaches 0.01 C. Note that 1 C is 137 mA/g here. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere.

### <<XRD>>

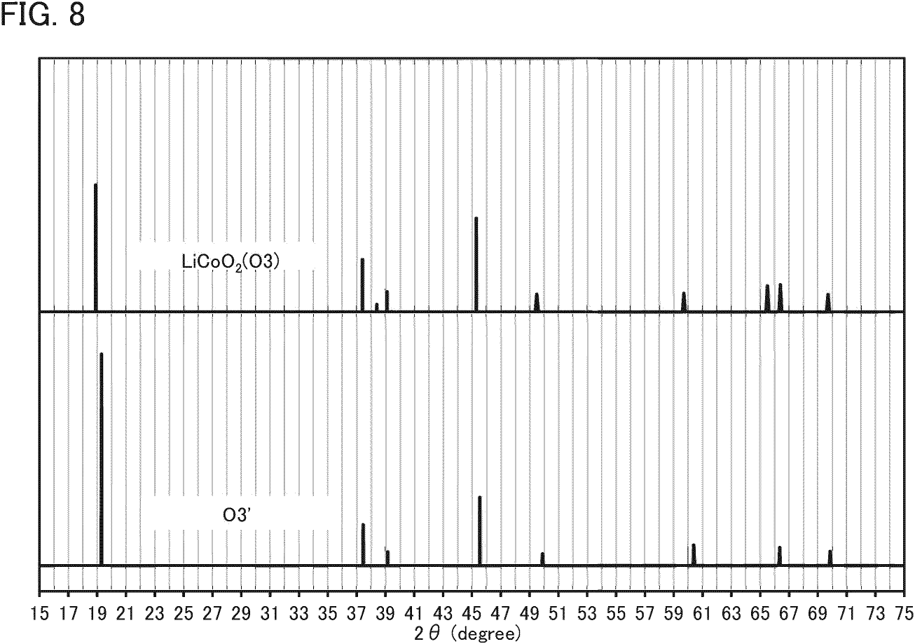

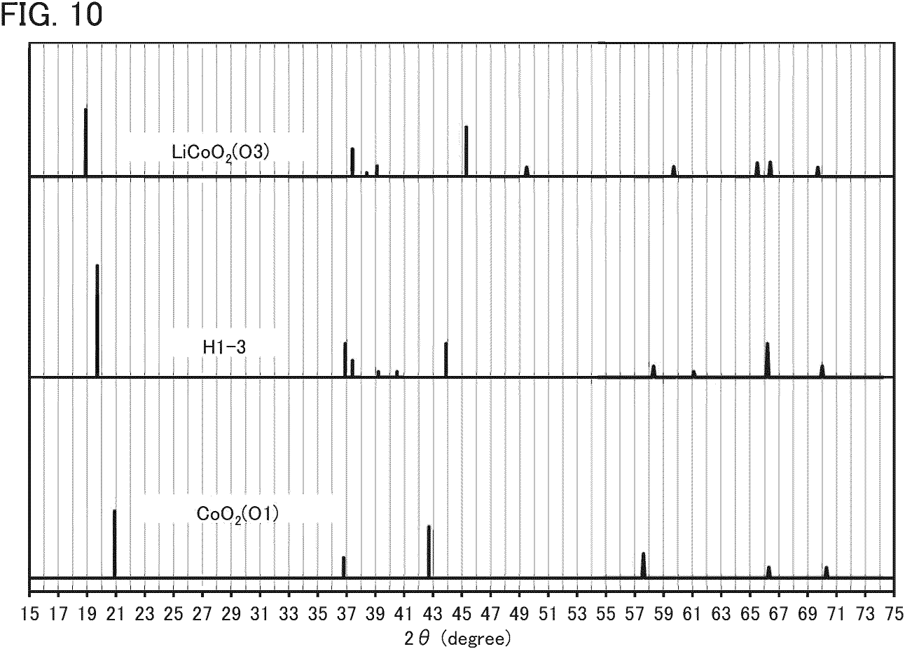

FIG. 8 and FIG. 10 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) were made from crystal structure data obtained from the Inorganic Crystal Structure Database (ICSD) (see Non-Patent Document 3) with Reflex Powder Diffraction, which is a module of Materials Studio (BIOVIA). The range of 2θ was from 15° to 75°, the step size was 0.01, the wavelength λ1 was 1.540562 × 10⁻¹⁰ m, the wavelength λ2 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS Version 3 (crystal structure analysis software produced by Bruker Corporation), and the XRD pattern of the O3′ type crystal structure was made in a similar manner to other structures.

As shown in FIG. 8, the O3′ type crystal structure exhibits diffraction peaks at 20 of 19.30±0.20° (greater than or equal to 19.10° and less than or equal to 19.50°) and 2θ of 45.55±0.10° (greater than or equal to 45.45° and less than or equal to 45.65°). More specifically, the O3′ type crystal structure exhibits sharp diffraction peaks at 20 of 19.30±0.10° (greater than or equal to 19.20° and less than or equal to 19.40°) and 20 of 45.55±0.05° (greater than or equal to 45.50° and less than or equal to 45.60). By contrast, as shown in FIG. 10, the H1-3 type crystal structure and CoO₂ (P-3m1, O1) do not exhibit peaks at these positions. Thus, the peaks at 20 of 19.30±0.20° and 2θ of 45.55±0.10° in a high voltage charged state with a large charge depth that causes extraction of a large amount of lithium can be the features of the positive electrode active material 100 of one embodiment of the present invention.

It can be said that the positions of the XRD diffraction peaks exhibited by the crystal structure with a charge depth of 0 are close to those of the XRD diffraction peaks exhibited by the crystal structure at the time of high voltage charging. More specifically, it can be said that a difference in the positions of two or more, preferably three or more of the main diffraction peaks between the crystal structures is 2θ = 0.7 or less, preferably 20 = 0.5 or less.

Although the positive electrode active material 100 of one embodiment of the present invention has the O3′ type crystal structure at the time of high voltage charging, not all the particles necessarily have the O3′ type crystal structure. Some of the particles may have another crystal structure or be amorphous. Note that when the XRD patterns are subjected to the Rietveld analysis, the O3′ type crystal structure preferably accounts for greater than or equal to 50 wt%, further preferably greater than or equal to 60 wt%, still further preferably greater than or equal to 66 wt%. The positive electrode active material in which the O3′ type crystal structure accounts for greater than or equal to 50 wt%, preferably greater than or equal to 60 wt%, further preferably greater than or equal to 66 wt% can have sufficiently good cycle performance.

Furthermore, even after 100 or more cycles of charging and discharging after the measurement starts, the O3′ type crystal structure preferably accounts for greater than or equal to 35 wt%, further preferably greater than or equal to 40 wt%, still further preferably greater than or equal to 43 wt%, in the Rietveld analysis.

The crystallite size of the O3′ type crystal structure of the positive electrode active material particle is only decreased to approximately one-tenth that of LiCoO₂ (O3) in a discharged state. Thus, the peak of the O3′ type crystal structure can be clearly observed after high voltage charging even under the same XRD measurement conditions as those of a positive electrode before charging and discharging. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

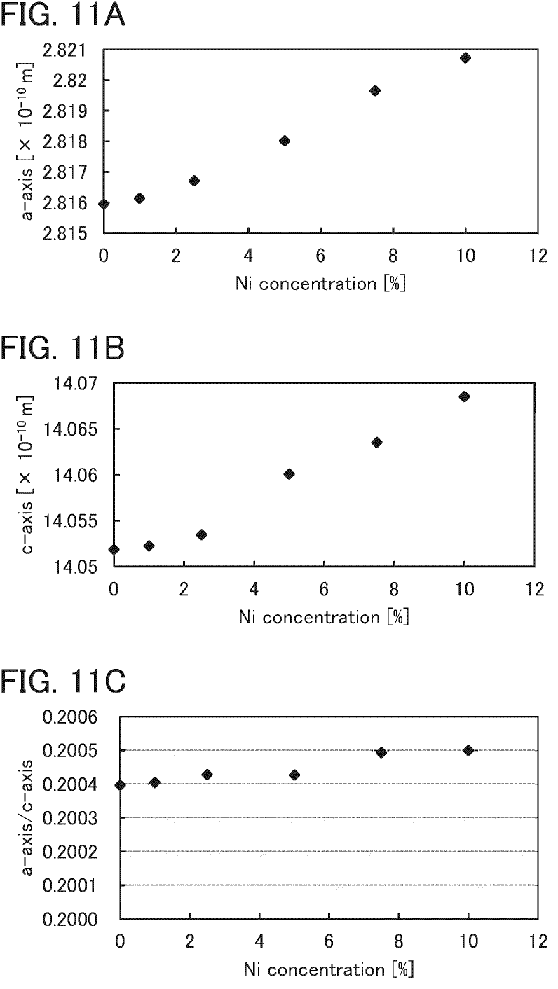

FIG. 11 shows the estimation results of the lattice constants of the a-axis and the c-axis by XRD in the case where the positive electrode active material of one embodiment of the present invention has the layered rock-salt crystal structure and includes cobalt and nickel. FIG. 11A shows the results of the a-axis, and FIG. 11B shows the results of the c-axis. Note that the XRD of a powder after the synthesis of the positive electrode active material before incorporation into a positive electrode is shown in FIG. 11. The nickel concentration on the horizontal axis represents a nickel concentration with the sum of cobalt atoms and nickel atoms regarded as 100%. The positive electrode active material was formed through Step S21 to Step S25, which are described later, and a cobalt source and a nickel source were used in Step S21. The nickel concentration represents a nickel concentration with the sum of cobalt atoms and nickel atoms regarded as 100% in Step S21.

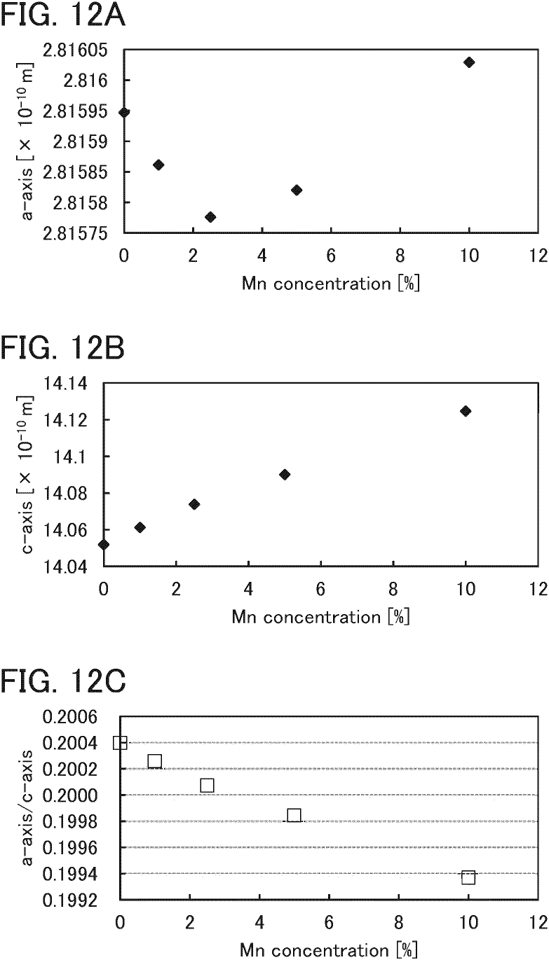

FIG. 12 shows the estimation results of the lattice constants of the a-axis and the c-axis by XRD in the case where the positive electrode active material of one embodiment of the present invention has the layered rock-salt crystal structure and includes cobalt and manganese. FIG. 12A shows the results of the a-axis, and FIG. 12B shows the results of the c-axis. Note that the XRD of a powder after the synthesis of the positive electrode active material before incorporation into a positive electrode is shown in FIG. 12. The manganese concentration on the horizontal axis represents a manganese concentration with the sum of cobalt atoms and manganese atoms regarded as 100%. The positive electrode active material was formed through Step S21 to Step S25, which are described later, and a cobalt source and a manganese source were used in Step S21. The manganese concentration represents a manganese concentration with the sum of cobalt atoms and manganese atoms regarded as 100% in Step S21.

FIG. 11C shows values obtained by dividing the lattice constants of the a-axis by the lattice constants of the c-axis (a-axis/c-axis) in the positive electrode active material, whose results of the lattice constants are shown in FIG. 11A and FIG. 11B. FIG. 12C shows values obtained by dividing the lattice constants of the a-axis by the lattice constants of the c-axis (a-axis/c-axis) in the positive electrode active material, whose results of the lattice constants are shown in FIG. 12A and FIG. 12B.

As shown in FIG. 11C, the value of a-axis/c-axis tends to significantly change between nickel concentrations of 5% and 7.5%, and the distortion of the a-axis probably becomes large. This distortion may be the Jahn-Teller distortion. It is suggested that an excellent positive electrode active material with small Jahn-Teller distortion can be obtained at a nickel concentration of lower than 7.5%.

FIG. 12A indicates that the lattice constant changes differently at manganese concentrations of 5% or higher and does not follow the Vegard’s law. This suggests that the crystal structure changes at manganese concentrations of 5% or higher. Thus, the manganese concentration is preferably 4% or lower, for example.

Note that the nickel concentration and the manganese concentration in the surface portion 100a of the particle are not limited to the above ranges. In other words, the nickel concentration and the manganese concentration in the surface portion 100a of the particle may be higher than the above concentrations in some cases.

Preferable ranges of the lattice constants of the positive electrode active material of one embodiment of the present invention are examined above. In the layered rock-salt crystal structure of the particle of the positive electrode active material in a discharged state or a state where charging and discharging are not performed, which can be estimated from the XRD patterns, the a-axis lattice constant is preferably greater than 2.814 × 10⁻¹⁰ m and less than 2.817 × 10⁻¹⁰ m, and the c-axis lattice constant is preferably greater than 14.05 × 10⁻¹⁰ m and less than 14.07 × 10⁻¹⁰ m. The state where charging and discharging are not performed may be the state of a powder before the formation of a positive electrode of a secondary battery.

Alternatively, in the layered rock-salt crystal structure of particle of the positive electrode active material in the discharged state or the state where charging and discharging are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charging and discharging are not performed is subjected to XRD analysis, a first peak is observed at 20 of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a or the like can be analyzed by electron diffraction of a cross section of the positive electrode active material 100, for example.

### <<XPS>>

A region that is approximately 2 nm to 8 nm (normally, approximately 5 nm) in depth from a surface can be analyzed by X-ray photoelectron spectroscopy (XPS); thus, the concentrations of elements in approximately half the surface portion 100a can be quantitatively analyzed. The bonding states of the elements can be analyzed by narrow scanning. Note that the quantitative accuracy of XPS is approximately ±1 atomic% in many cases. The lower detection limit is approximately 1 atomic% but depends on the element.

When the positive electrode active material 100 of one embodiment of the present invention is subjected to XPS analysis, the number of atoms of the additive is preferably greater than or equal to 1.6 times and less than or equal to 6.0 times, further preferably greater than or equal to 1.8 times and less than 4.0 times the number of atoms of the transition metal. When the additive is magnesium and the transition metal is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal.

In the XPS analysis, monochromatic aluminum can be used as an X-ray source, for example. An extraction angle is, for example, 45°.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additives that preferably exist in the surface portion 100a in a large amount, such as magnesium and aluminum, measured by XPS or the like are preferably higher than the concentrations measured by ICP-MS (inductively coupled plasma mass spectrometry), GD-MS (glow discharge mass spectrometry), or the like.

When a cross section of the positive electrode active material 100 is exposed by processing and analyzed by TEM-EDX, the concentrations of magnesium and aluminum in the surface portion 100a are preferably higher than those in the inner portion 100b. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals, not be unevenly distributed in the surface portion 100a but be distributed in the entire positive electrode active material 100. Note that one embodiment of the present invention is not limited thereto in the case where the above-described region where the excess additive is unevenly distributed exists.

### <<Charge Curve and dQ/dV vs V Curve>>

An unbalanced phase change is presumed to occur around a peak in a dQ/dV curve obtained by differentiating capacitance (Q) with voltage (V) (dQ/dV) from the charge curve, resulting in a large change in the crystal structure. Note that in this specification and the like, an unbalanced phase change refers to a phenomenon that causes a nonlinear change in physical quantity.

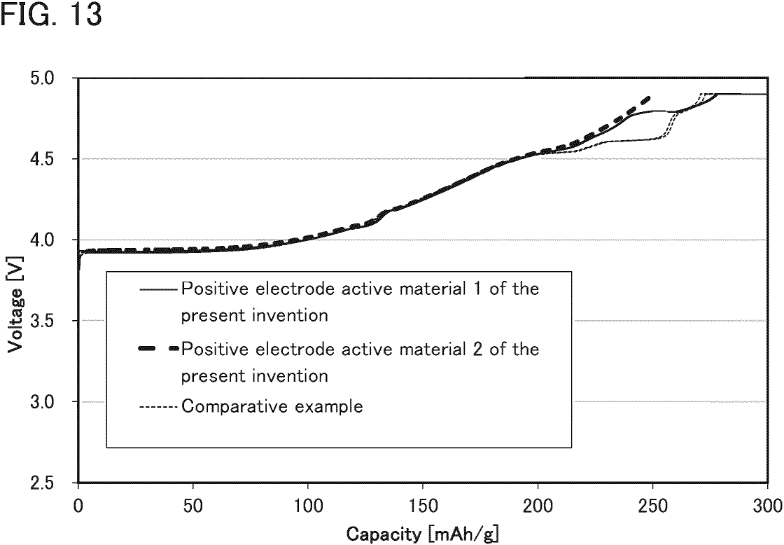

FIG. 13 shows charge curves of secondary batteries using the positive electrode active materials of embodiments of the present invention and a secondary battery using a positive electrode active material of a comparative example.

The positive electrode active material 1 of the present invention in FIG. 13 was formed by a formation method based on FIG. 1A of Embodiment 1. More specifically, the positive electrode active material 1 was formed by using lithium cobalt oxide (C-10N, manufactured by Nippon Chemical Industrial Co., Ltd.) as LiMO₂ in Step S14, mixing LiF and MgF₂, and performing heating. With the use of the positive electrode active material, the secondary battery was fabricated and charged in a manner similar to that of the fabrication and charging for the XRD measurement.

The positive electrode active material 2 of the present invention in FIG. 13 was formed by a formation method referring to FIG. 1A of Embodiment 1. More specifically, the positive electrode active material 2 was formed by using lithium cobalt oxide (C-10N, manufactured by Nippon Chemical Industrial Co., Ltd.) as LiMO₂ in Step S14, mixing LiF, MgF₂, Ni(OH)₂, and Al(OH)₃, and performing heating. With the use of the positive electrode active material, the secondary battery was fabricated and charged in a manner similar to that of the fabrication and charging for the XRD measurement.

The positive electrode active material of the comparative example in FIG. 13 was formed by forming a layer containing aluminum on a surface of lithium cobalt oxide (C-5H, manufactured by Nippon Chemical Industrial Co., Ltd.) by a sol-gel method and performing heating at 500° C. for 2 hours. With the use of the positive electrode active material, the secondary battery was fabricated and charged in a manner similar to that of the fabrication and charging for the XRD measurement.

The charge curves in FIG. 13 are of the secondary batteries charged up to 4.9 V at 25° C. at 10 mAh/g. Note that n of the positive electrode active material 1 and the comparative example is 2, and n of the positive electrode active material 2 is 1.

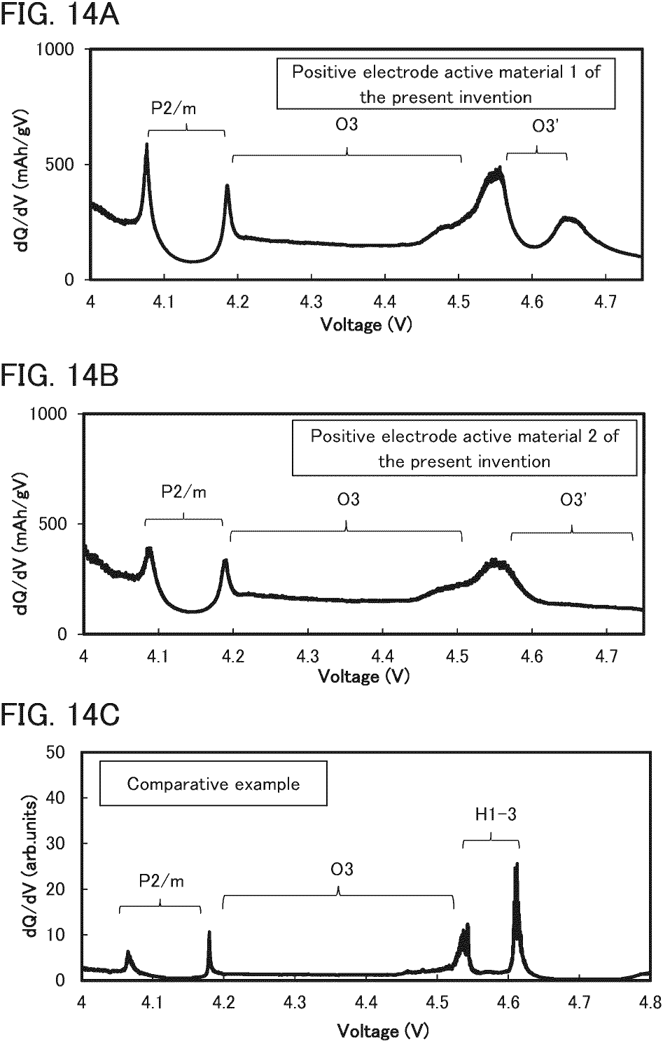

FIG. 14A to FIG. 14C show dQ/dV vs V curves obtained from the data of FIG. 13, which represent the amount of change in voltage with respect to the charge capacity. FIG. 14A shows the dQ/dV vs V curve of the secondary battery using the positive electrode active material 1 of one embodiment of the present invention, FIG. 14B shows the dQ/dV vs V curve of the secondary battery using the positive electrode active material 2 of one embodiment of the present invention, and FIG. 14C shows the dQ/dV vs V curve of the secondary battery using the positive electrode active material of the comparative example.

As apparent from FIG. 14A to FIG. 14C, in each of the embodiments of the present invention and the comparative example, peaks were observed at voltages of approximately 4.06 V and approximately 4.18 V, and the change in capacity with respect to voltage was nonlinear. The crystal structure at a charge depth of 0.5 (space group P2/m) was probably between these two peaks. In the space group P2/m with a charge depth of 0.5, lithium is arranged as illustrated in FIG. 9. It is suggested that energy was used for this lithium arrangement, and thus the change in capacity with respect to voltage became nonlinear.

In addition, in the comparative example of FIG. 14B, large peaks were observed at approximately 4.54 V and approximately 4.61 V. An H1-3 phase type crystal structure probably exists between these two peaks.

Meanwhile, in the secondary batteries of embodiments of the present invention of FIG. 14A and FIG. 14B showing extremely excellent cycle performance, a small peak was observed at approximately 4.55 V but it was not clear. Moreover, the positive electrode active material 2 does not show the next peak at voltages exceeding 4.7 V, suggesting that the O3′ structure was kept. Thus, in the dQ/dV vs V curves of the secondary batteries using the positive electrode active materials of embodiments of the present invention, some peaks might be extremely broad or small at 25° C. In such a case, there is a possibility that two crystal structures coexist. For example, two phases of O3 and O3′ may coexist, or two phases of O3′ and H1-3 may coexist.

### <<Discharge Curve and dQ/dV vs V Curve>>

Moreover, when the positive electrode active material of one embodiment of the present invention is discharged at a low rate of, for example, 0.2 C or less after high-voltage charging, a characteristic change in voltage appears just before the end of discharging, in some cases. This change can be clearly observed by the fact that at least one peak appears within the range to 3.5 V at a voltage lower than that of a peak which appears around 3.9 V in dQ/dV vs V calculated from a discharge curve.

### <<Surface Roughness and Specific Surface Area>>

The positive electrode active material 100 of one embodiment of the present invention preferably has a smooth surface with little unevenness. A smooth surface with little unevenness indicates favorable distribution of the additive in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subj ected to noise processing using image processing software. For example, the Gaussian Blur (a = 2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With the use of the function of the spreadsheet software or the like, correction was performed using regression curves (quadratic regression), parameters for calculating roughness were obtained from data subjected to slope correction, and root-mean-square surface roughness (RMS) was obtained by calculating standard deviation. This surface roughness refers to the surface roughness of part of the particle periphery (at least 400 nm) of the positive electrode active material.

On the surface of the particle of the positive electrode active material 100 of this embodiment, roughness (RMS: root-mean-square surface roughness), which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably less than or equal to 2.

This embodiment can be used in appropriate combination with any of the other embodiments.

### Embodiment 2

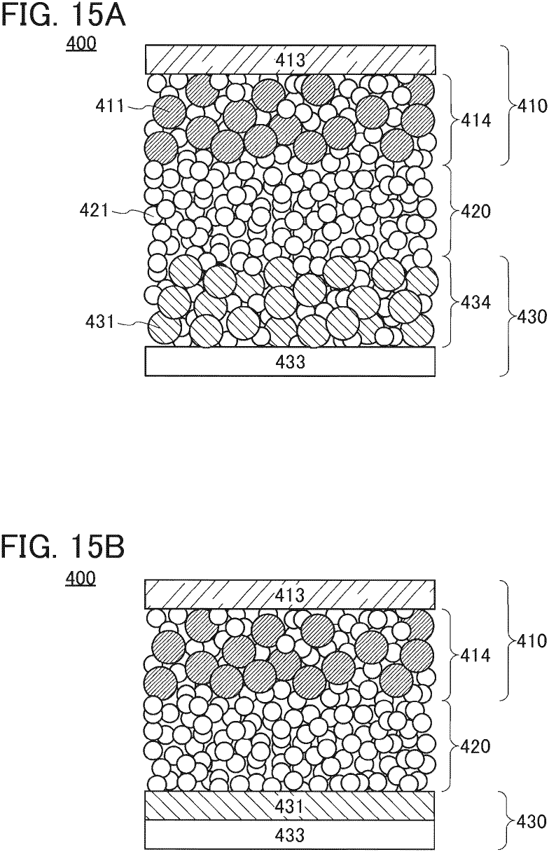

In this embodiment, examples of a secondary battery of one embodiment of the present invention are described with reference to FIG. 15 to FIG. 17.

### <Structure Example 1 of Secondary Battery>

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material and a binder. As the positive electrode, the positive electrode formed by the formation method described in the above embodiment is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ and/or LiNi₁₋ₓMₓO₂ (0 < x < 1) (M = Co, Al, or the like)) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0 < a/(b+c) < 2; c > 0; and 0.26 ≤ (b+c)/d < 0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, y-butyrolactone, y-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a secondary battery from exploding or catching fire even when the secondary battery internally shorts out and/or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and/or aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains a small number of dust particles and/or elements other than the constituent elements of the electrolyte solution (hereinafter, also simply referred to as impurities). Specifically, the weight ratio of impurities to the electrolyte solution is preferably less than or equal to 1 %, further preferably less than or equal to 0.1 %, still further preferably less than or equal to 0.01 %.

Furthermore, an additive agent such as vinylene carbonate, propane sultone (PS), tertbutylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt% and lower than or equal to 5 wt%.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and/or a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may alternatively be used. When the solid electrolyte is used, a separator and/or a spacer are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Structure Example 2 of Secondary Battery>

A structure of a secondary battery including a solid electrolyte layer is described below as another structure example of a secondary battery.

As illustrated in FIG. 15A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, it is possible that the negative electrode 430 does not include the solid electrolyte 421 as illustrated in FIG. 15B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{⅔-X}Li₃ₓTiO₃), a material with a NASICON crystal structure (e.g., Li₁₋ₓAlxTi_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄-Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0 [ x [ 1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

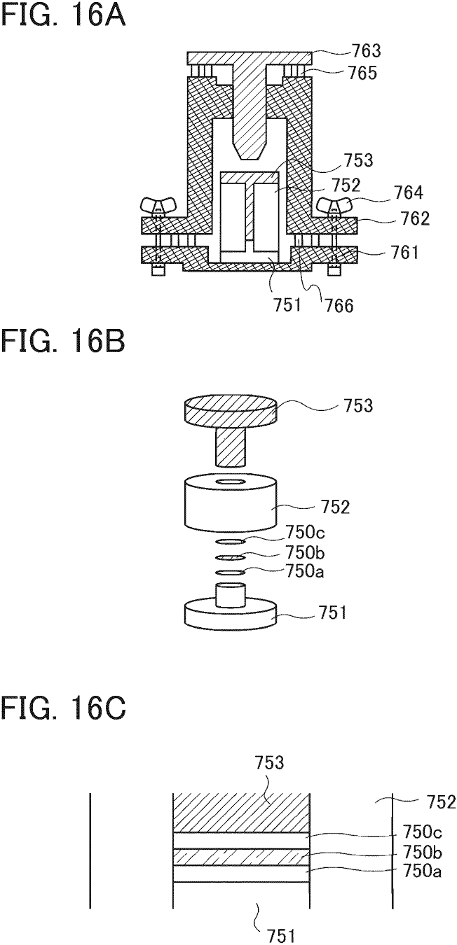

FIG. 16 shows an example of a cell for evaluating materials of an all-solid-state battery.

FIG. 16A is a schematic cross-sectional view of the evaluation cell. The evaluation cell includes a lower component 761, an upper component 762, and/or a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 16B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 16C. Note that the same portions in FIG. 16A, FIG. 16B, and FIG. 16C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

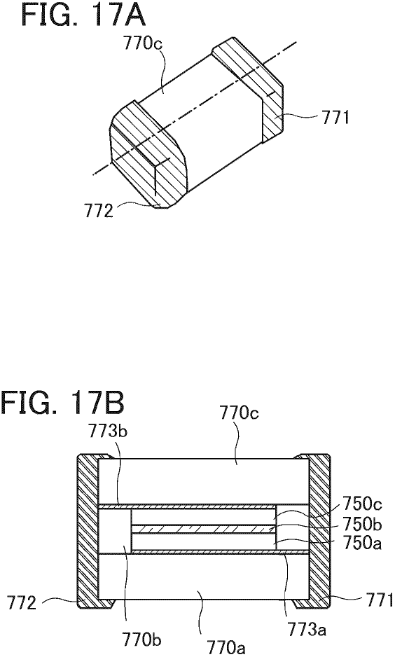

FIG. 17A is a perspective view of a secondary battery of one embodiment of the present invention that has an exterior body and a shape different from those in FIG. 16. The secondary battery in FIG. 17A includes external electrodes 771 and 772 and is sealed with an exterior body including a plurality of package components.

FIG. 17B illustrates an example of a cross section along the dashed-dotted line in FIG. 17A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be used in appropriate combination with any of the other embodiments.

### Embodiment 3

In this embodiment, examples of a shape of a secondary battery containing the positive electrode described in the above embodiment are described. For the materials used for the secondary battery described in this embodiment, the description of the above embodiment can be referred to.

### <Coin-Type Secondary Battery>

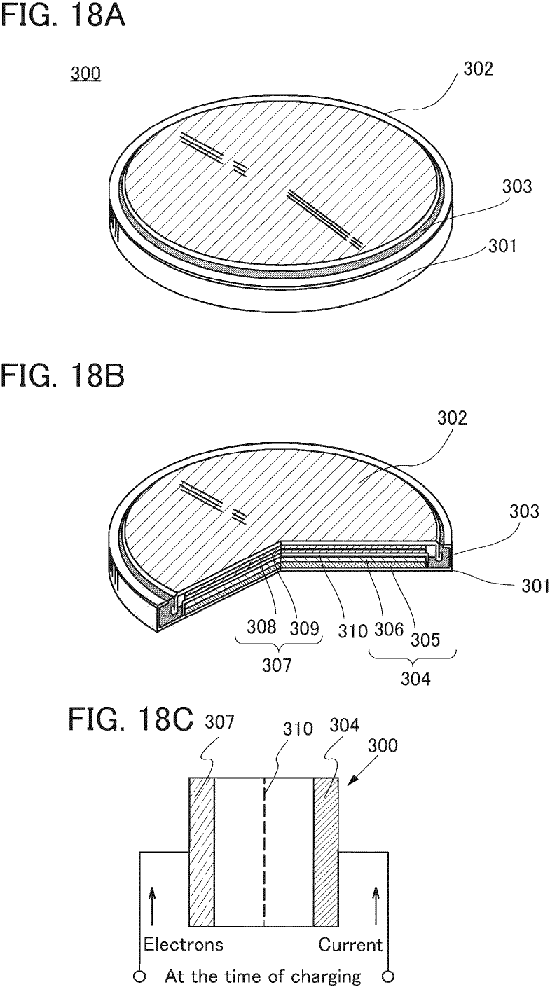

First, an example of a coin-type secondary battery is described. FIG. 18A is an external view of a coin-type (single-layer flat type) secondary battery, and FIG. 18B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, and/or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte solution. Then, as illustrated in FIG. 18B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high capacity and excellent cycle performance can be obtained.

Here, a current flow in charging a secondary battery is described with reference to FIG. 18C. When a secondary battery using lithium is regarded as a closed circuit, movement of lithium ions and the current flow are in the same direction. Note that in the secondary battery using lithium, the anode and the cathode interchange in charge and discharge, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charging current is supplied. The use of the term “anode” or “cathode” related to an oxidation reaction or a reduction reaction might cause confusion because the anode and the cathode interchange in charge and discharge. Thus, the term “anode” or “cathode” is not used in this specification. If the term “anode” or “cathode” is used, it should be mentioned that the anode or the cathode is which of the one at the time of charge or the one at the time of discharge and corresponds to which of a positive (plus) electrode or a negative (minus) electrode.

Two terminals illustrated in FIG. 18C are connected to a charger, and the secondary battery 300 is charged. As the charge of the secondary battery 300 proceeds, a potential difference between electrodes increases.

### <Cylindrical Secondary Battery>

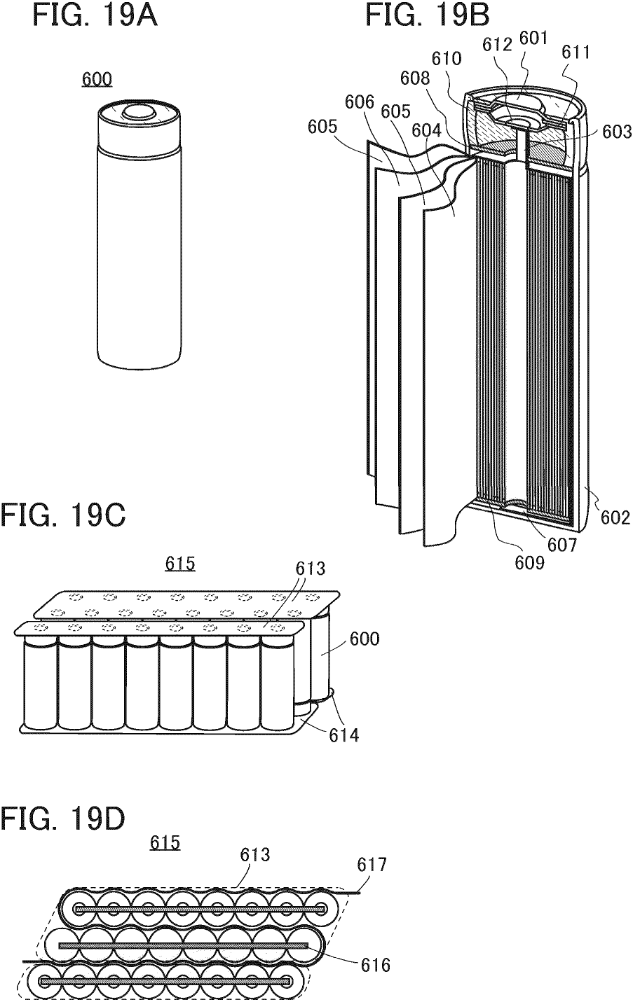

Next, an example of a cylindrical secondary battery is described with reference to FIG. 19. FIG. 19A shows an external view of a cylindrical secondary battery 600. FIG. 19B is a schematic cross-sectional view of the cylindrical secondary battery 600. The cylindrical secondary battery 600 includes, as illustrated in FIG. 19B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, and/or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Furthermore, as illustrated in FIG. 19C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 19D is a top view of the module 615. The conductive plate 613 is shown by a dotted line for clarity of the diagram. As illustrated in FIG. 19D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### <Structure Examples of Secondary Battery>

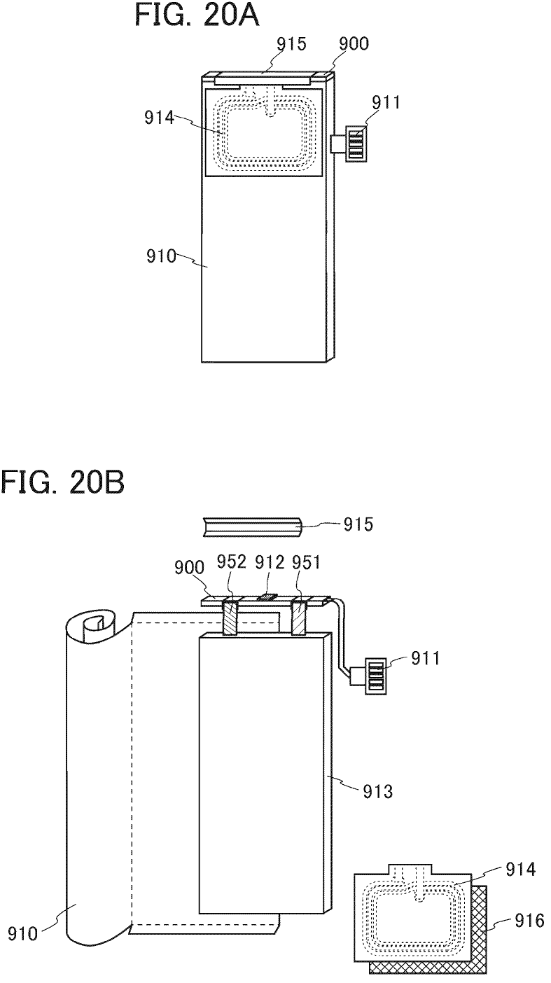

Other structure examples of secondary batteries are described with reference to FIG. 20 to FIG. 24.

FIG. 20A and FIG. 20B are external views of a battery pack. The battery pack includes a secondary battery 913 and a circuit board 900. A secondary battery 913 is connected to an antenna 914 through a circuit board 900. A label 910 is attached to the secondary battery 913. In addition, as illustrated in FIG. 20B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 20.

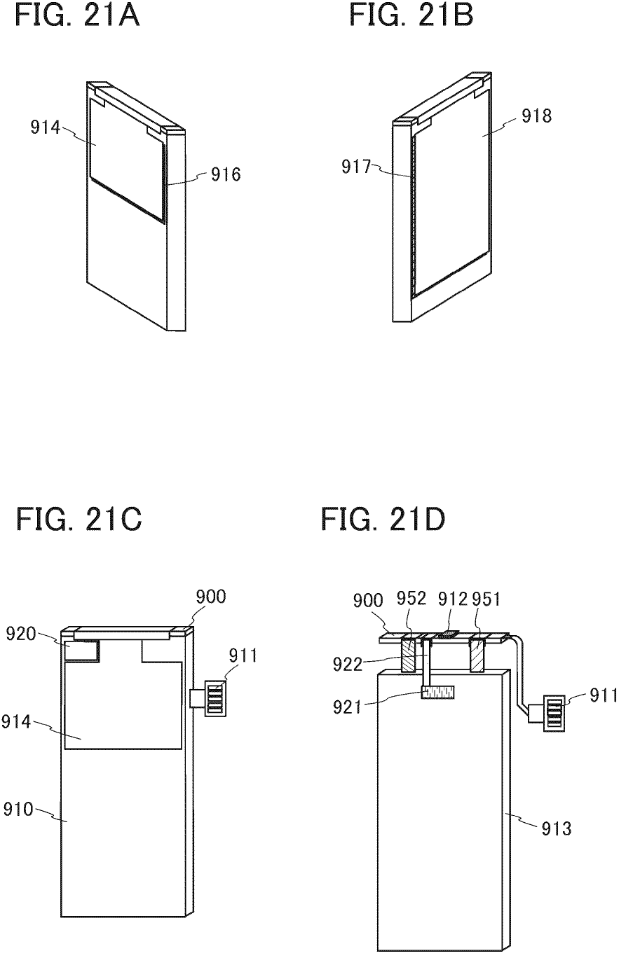

For example, as illustrated in FIG. 21A and FIG. 21B, two opposite surfaces of the secondary battery 913 illustrated in FIG. 20A and FIG. 20B may be provided with respective antennas. FIG. 21A is an external view seen from one side of the opposite surfaces, and FIG. 21B is an external view seen from the other side of the opposite surfaces. Note that for portions similar to those of the secondary battery illustrated in FIG. 20A and FIG. 20B, the description of the secondary battery illustrated in FIG. 20A and FIG. 20B can be appropriately referred to.

As illustrated in FIG. 21A, the antenna 914 is provided on one of the opposite surfaces of the secondary battery 913 with the layer 916 located therebetween, and as illustrated in FIG. 21B, an antenna 918 is provided on the other of the opposite surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 21C, the secondary battery 913 illustrated in FIG. 20A and FIG. 20B may be provided with a display device 920. The display device 920 is electrically connected to the terminal 911. Note that the label 910 is not necessarily provided in a portion where the display device 920 is provided. Note that for portions similar to those of the secondary battery illustrated in FIG. 20A and FIG. 20B, the description of the secondary battery illustrated in FIG. 20A and FIG. 20B can be appropriately referred to.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 21D, the secondary battery 913 illustrated in FIG. 20A and FIG. 20B may be provided with a sensor 921. The sensor 921 is electrically connected to the terminal 911 via a terminal 922. Note that for portions similar to those of the secondary battery illustrated in FIG. 20A and FIG. 20B, the description of the secondary battery illustrated in FIG. 20A and FIG. 20B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

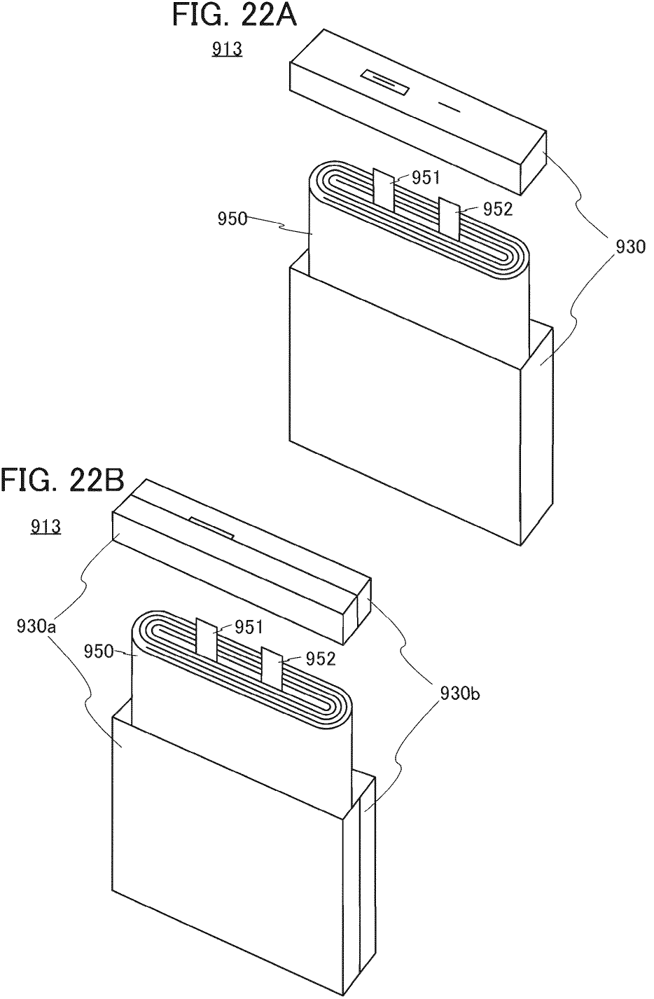

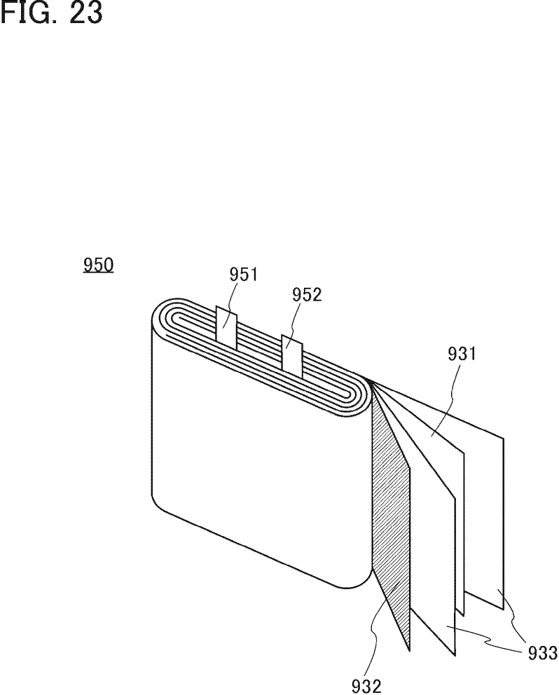

Furthermore, structure examples of the secondary battery 913 are described with reference to FIG. 22 and FIG. 23.

The secondary battery 913 illustrated in FIG. 22A includes a wound body 950 provided with the terminal 951 and the terminal 952 inside a housing 930. The wound body 950 is soaked in an electrolyte solution inside the housing 930. The terminal 952 is in contact with the housing 930. The use of an insulator or the like prevents contact between the terminal 951 and the housing 930. Note that in FIG. 22A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 22B, the housing 930 illustrated in FIG. 22A may be formed using a plurality of materials. For example, in the secondary battery 913 illustrated in FIG. 22B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 23 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 20 via one of the terminal 951 and the terminal 952. The positive electrode 932 is connected to the terminal 911 illustrated in FIG. 20 via the other of the terminal 951 and the terminal 952.

When the positive electrode active material described in the above embodiment is used in the positive electrode 932, the secondary battery 913 with high capacity and excellent cycle performance can be obtained.

### <Laminated Secondary Battery>

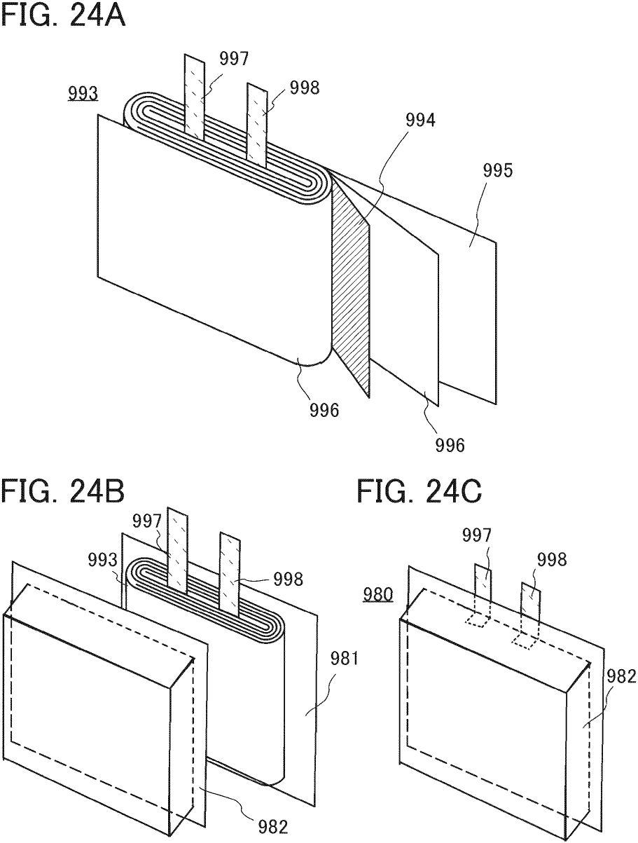

Next, an example of a laminated secondary battery is described with reference to FIG. 24 to FIG. 36. When the laminated secondary battery has flexibility, the secondary battery can be used in an electronic device at least part of which is flexible and can be bent as the electronic device is bent.

A laminated secondary battery 980 is described with reference to FIG. 24. The laminated secondary battery 980 includes a wound body 993 illustrated in FIG. 24A. The wound body 993 includes a negative electrode 994, a positive electrode 995, and separators 996. The wound body 993 is, like the wound body 950 illustrated in FIG. 23, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be designed as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 24B, the above-described wound body 993 is packed in a space formed by bonding a film 981 and a film 982 having a depressed portion that serve as exterior bodies by thermocompression bonding or the like, whereby the secondary battery 980 as illustrated in FIG. 24C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum and/or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 24B and FIG. 24C show an example of using two films, the wound body 993 may be placed in a space formed by bending one film.

When the positive electrode active material described in the above embodiment is used in the positive electrode 995, the secondary battery 980 with high capacity and excellent cycle performance can be obtained.

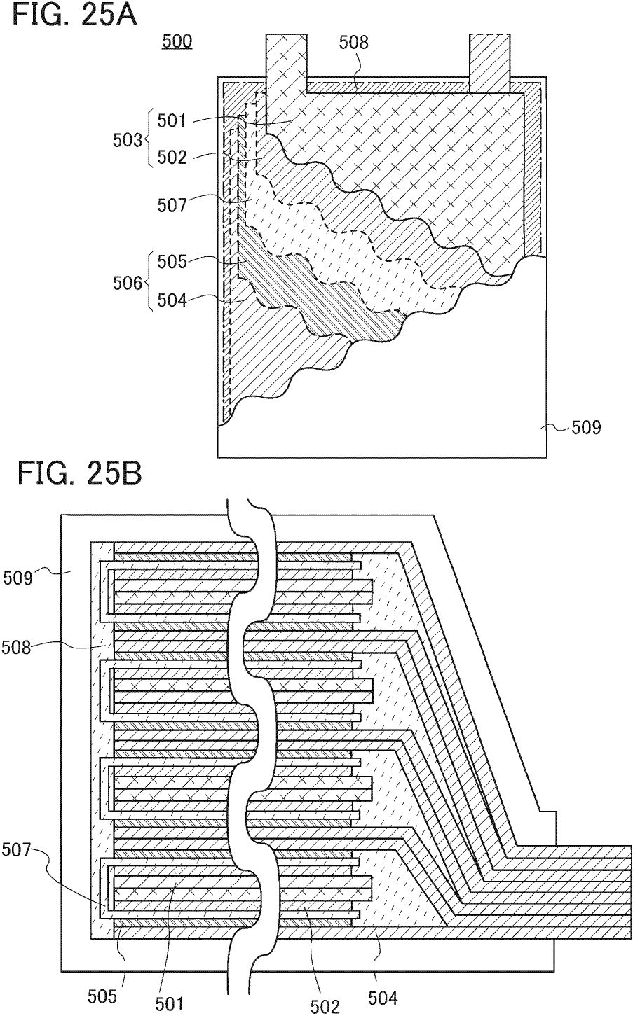

In FIG. 24, an example in which the secondary battery 980 includes a wound body in a space formed by films serving as exterior bodies is described; however, as illustrated in FIG. 25, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 25A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 illustrated in FIG. 25A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 25B shows an example of a cross-sectional structure of the laminated secondary battery 500. FIG. 25A shows an example in which only two current collectors are included for simplicity, but actually, a plurality of electrode layers are included as illustrated in FIG. 25B.

In FIG. 25B, the number of electrode layers is 16, for example. Note that the secondary battery 500 has flexibility even though the number of electrode layers is set to 16. FIG. 25B illustrates a structure including 8 layers of negative electrode current collectors 504 and 8 layers of positive electrode current collectors 501, i.e., 16 layers in total. Note that FIG. 25B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high capacity. In contrast, with a small number of electrode layers, the secondary battery can have small thickness and high flexibility.

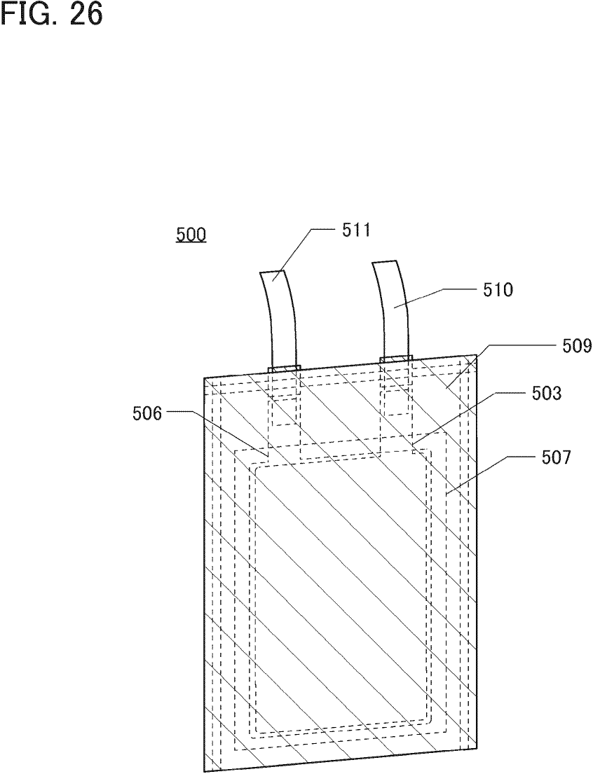

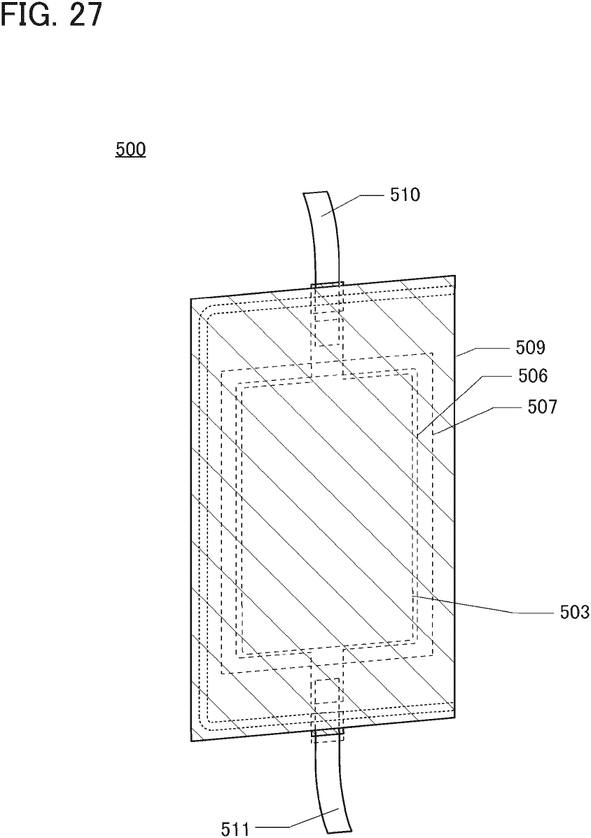

FIG. 26 and FIG. 27 each show an example of the external view of the laminated secondary battery 500. In FIG. 26 and FIG. 27, the positive electrode 503, the negative electrode 506, the separator 507, the exterior body 509, a positive electrode lead electrode 510, and a negative electrode lead electrode 511 are included.

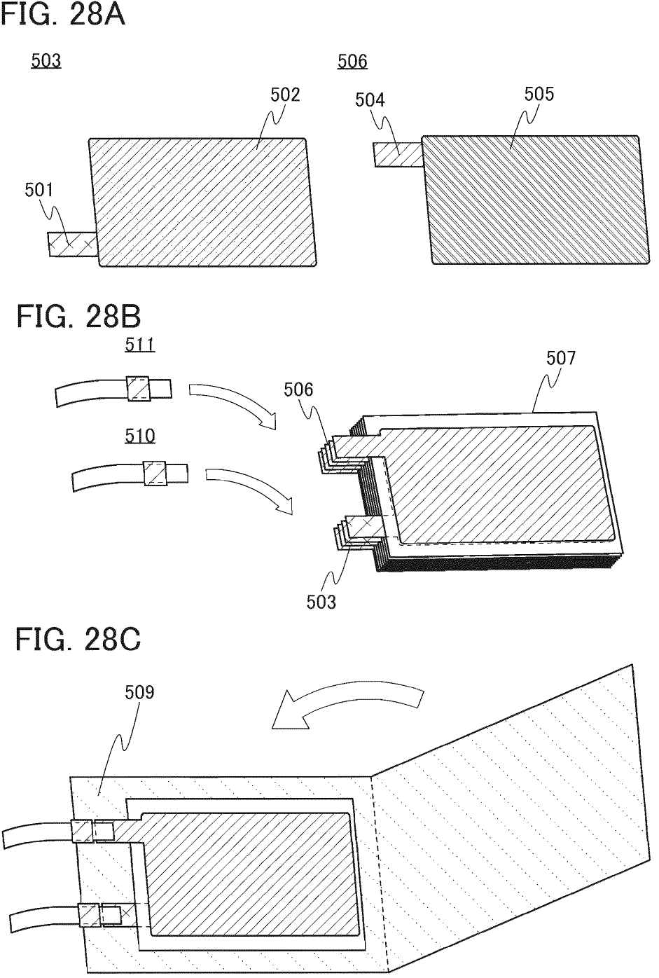

FIG. 28A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and/or the shapes of the tab regions included in the positive electrode and the negative electrode are not limited to those illustrated in FIG. 28A.

### <Method for Manufacturing Laminated Secondary Battery>

Here, an example of a method for manufacturing the laminated secondary battery whose external view is illustrated in FIG. 26 is described with reference to FIG. 28B and FIG. 28C.

First, the negative electrode 506, the separator 507, and the positive electrode 503 are stacked. FIG. 28B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 28C. Then, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated secondary battery 500 can be manufactured.

When the positive electrode active material described in the above embodiment is used in the positive electrode 503, the secondary battery 500 with high capacity and excellent cycle performance can be obtained.

### <Bendable Secondary Battery>

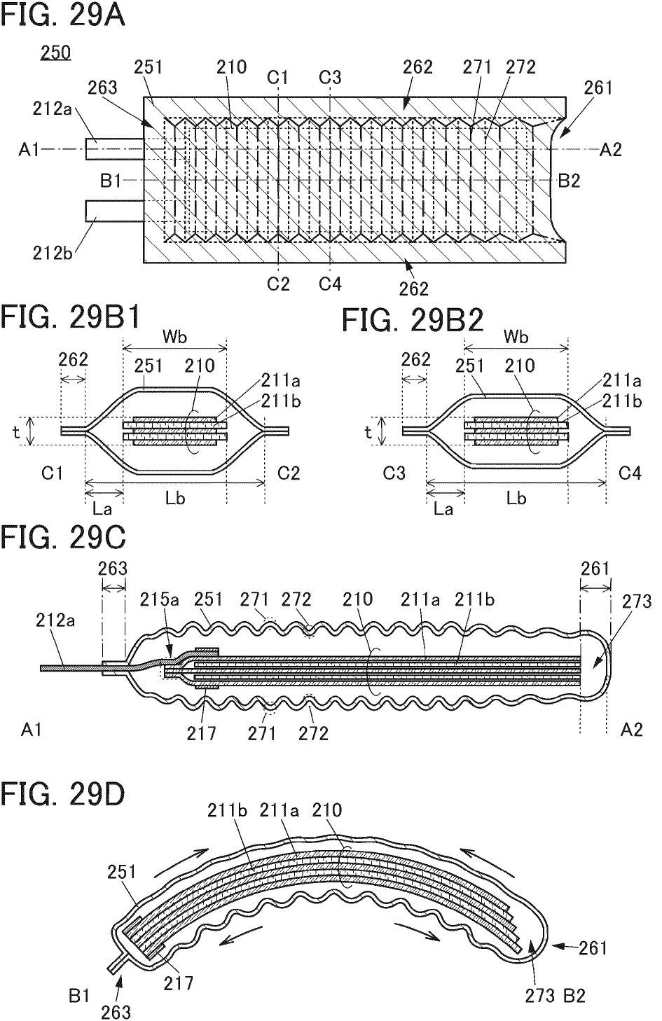

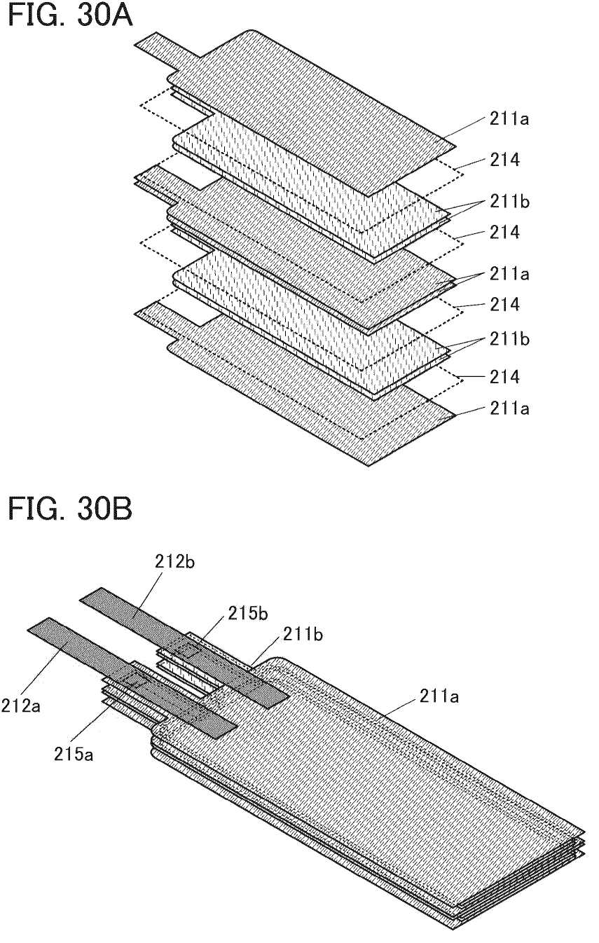

Next, an example of a bendable secondary battery is described with reference to FIG. 29 and FIG. 30.

FIG. 29A is a schematic top view of a bendable secondary battery 250. FIG. 29B1, FIG. 29B2, and FIG. 29C are schematic cross-sectional views taken along the cutting line C1-C2, the cutting line C3-C4, and the cutting line A1-A2, respectively, in FIG. 29A. The secondary battery 250 includes an exterior body 251 and positive electrodes 211a and negative electrodes 211b which are held in the exterior body 251. The positive electrodes 211a and the negative electrodes 211b are collectively referred to as an electrode member 210. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

The positive electrode 211a and the negative electrode 211b included in the secondary battery 250 are described with reference to FIG. 30. FIG. 30A is a perspective view illustrating the stacking order of the positive electrode 211a, the negative electrode 211b, and a separator 214. FIG. 30B is a perspective view illustrating the lead 212a and the lead 212b in addition to the positive electrode 211a and the negative electrode 211b.

As illustrated in FIG. 30A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab. A positive electrode active material layer is formed on one surface of the positive electrode 211a other than the tab, and a negative electrode active material layer is formed on one surface of the negative electrode 211b other than the tab.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material is not formed are in contact with each other.

Furthermore, the separator 214 is provided between the surface of the positive electrode 211a on which the positive electrode active material is formed and the surface of the negative electrode 211b on which the negative electrode active material is formed. In FIG. 30A and FIG. 30B, the separator 214 is shown by a dotted line for easy viewing.

Moreover, as illustrated in FIG. 30B, the plurality of positive electrodes 211a are electrically connected to the lead 212a in a bonding portion 215a. The plurality of negative electrodes 211b are electrically connected to the lead 212b in a bonding portion 215b.

Next, the exterior body 251 is described with reference to FIG. 29B1, FIG. 29B2, FIG. 29C, and FIG. 29D.

The exterior body 251 has a film-like shape and is folded in half so as to sandwich the positive electrodes 211a and the negative electrodes 211b. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 29B1 shows a cross section along the part overlapping with the crest line 271. FIG. 29B2 shows a cross section along the part overlapping with the trough line 272. FIG. 29B1 and FIG. 29B2 correspond to cross sections of the secondary battery 250, the positive electrodes 211a, and the negative electrodes 211b in the width direction.

Here, the distance between end portions of the positive electrode 211a and the negative electrode 211b in the width direction and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte solution. Therefore, the distance La is preferably set as long as possible. However, if the distance La is too long, the volume of the secondary battery 250 is increased.

Furthermore, the distance La between the positive electrode 211a and the negative electrode 211b, and the seal portion 262 is preferably increased as the total thickness of the positive electrode 211a and the negative electrode 211b that are stacked is increased.

Specifically, when the total thickness of the stacked positive electrodes 211a, negative electrodes 211b, and separators 214 (not illustrated) is t, the distance La is preferably 0.8 times or more and 3.0 times or less, further preferably 0.9 times or more and 2.5 times or less, and still further preferably 1.0 times or more and 2.0 times or less as large as the thickness t. When the distance La is in the above range, a compact battery highly reliable for bending can be obtained.

Furthermore, when the distance between the pair of seal portions 262 is referred to as a distance Lb, it is preferred that the distance Lb be sufficiently longer than the widths of the positive electrode 211a and the negative electrode 211b (here, a width Wb of the negative electrode 211b). Thus, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; thus, the positive electrode 211a and the negative electrode 211b can be effectively prevented from being rubbed against the exterior body 251.

For example, the difference between the distance Lb, which is the distance between the pair of seal portions 262, and the width Wb of the negative electrode 211b is preferably 1.6 times or more and 6.0 times or less, further preferably 1.8 times or more and 5.0 times or less, and still further preferably 2.0 times or more and 4.0 times or less as large as the thickness t of the positive electrode 211a and the negative electrode 211b.

In other words, the distance Lb, the width Wb, and the thickness t preferably satisfy the relationship of Formula 1 below.

### [Formula 1]

$$\frac{L b - W b}{2 \text{t}} \geq \text{a} \qquad \text{(Formula 1)}$$

Here, a satisfies 0.8 or more and 3.0 or less, preferably 0.9 or more and 2.5 or less, further preferably 1.0 or more and 2.0 or less.

FIG. 29C illustrates a cross section including a cross section of the lead 212a and corresponds to a cross section of the secondary battery 250, the positive electrode 211a, and the negative electrode 211b in the length direction. As illustrated in FIG. 29C, a space 273 is preferably provided between the end portions of the positive electrode 211a and the negative electrode 211b in the length direction and the exterior body 251 in the folded portion 261.

FIG. 29D is a schematic cross-sectional view of the secondary battery 250 in a state of being bent. FIG. 29D corresponds to a cross section along the cutting line B1-B2 in FIG. 29A.

When the secondary battery 250 is bent, a part of the exterior body 251 positioned on the outer side in bending is unbent and the other part positioned on the inner side changes its shape as it shrinks. More specifically, the part of the exterior body 251 positioned on the outer side changes its shape such that the wave amplitude becomes smaller and the length of the wave period becomes larger. In contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand or contract. Thus, the secondary battery 250 can be bent with weak force without damage to the exterior body 251.

As illustrated in FIG. 29D, when the secondary battery 250 is bent, the positive electrode 211a and the negative electrode 211b are shifted relatively. At this time, ends of the stacked positive electrodes 211a and negative electrodes 211b on the seal portion 263 side are fixed by a fixing member 217. Thus, the positive electrodes 211a and the negative electrodes 211b are shifted so that the shift amount becomes larger at a position closer to the bent portion 261. Therefore, stress applied to the positive electrode 211a and the negative electrode 211b is relieved, and the positive electrode 211a and the negative electrode 211b themselves do not need to expand or contract. Consequently, the secondary battery 250 can be bent without damage to the positive electrode 211a and the negative electrode 211b.

The space 273 is included between the positive electrode 211a and the negative electrode 211b, and the exterior body 251, whereby the positive electrode 211a and the negative electrode 211b can be shifted relatively while the positive electrode 211a and the negative electrode 211b located on an inner side in bending do not come into contact with the exterior body 251.

In the secondary battery 250 illustrated in FIG. 29 and FIG. 30, the exterior body is unlikely to be damaged and the positive electrode 211a and the negative electrode 211b are unlikely to be damaged, for example, and the battery characteristics are unlikely to deteriorate even when the secondary battery 250 is repeatedly bent and unbent. When the positive electrode active material described in the above embodiment is used in the positive electrode 211a included in the secondary battery 250, a battery with better cycle performance can be obtained.

In an all-solid-state battery, the contact state of the inside interfaces can be kept favorable by applying a predetermined pressure in the direction of stacking positive electrodes and/or negative electrodes. By applying a predetermined pressure in the direction of stacking positive electrodes and/or negative electrodes, expansion in the stacking direction due to charge and discharge of the all-solid-state battery can be suppressed, and the reliability of the all-solid-state battery can be improved.

This embodiment can be used in appropriate combination with any of the other embodiments.

### Embodiment 4

In this embodiment, examples of electronic devices each including the secondary battery of one embodiment of the present invention are described.

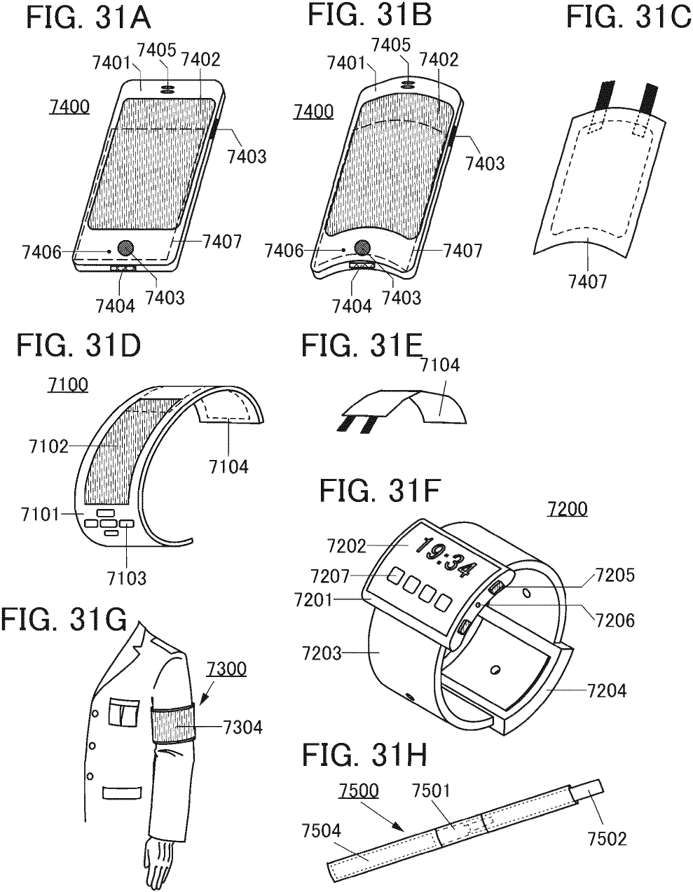

First, FIG. 31A to FIG. 31G show examples of electronic devices including the bendable secondary battery described in the above embodiment. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house or a building or a curved interior/exterior surface of an automobile.

FIG. 31A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 31B illustrates the mobile phone 7400 that is curved. When the whole mobile phone 7400 is curved by external force, the secondary battery 7407 provided therein is also curved. FIG. 31C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 31D shows an example of a bangle display device. A portable display device 7100 includes a housing 7101, a display portion 7102, operation buttons 7103, and a secondary battery 7104. FIG. 31E illustrates the bent secondary battery 7104. When the display device is worn on a user’s arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 31F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 31E that is in the state of being curved can be provided in the housing 7201. Alternatively, the secondary battery 7104 illustrated in FIG. 31E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 31G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

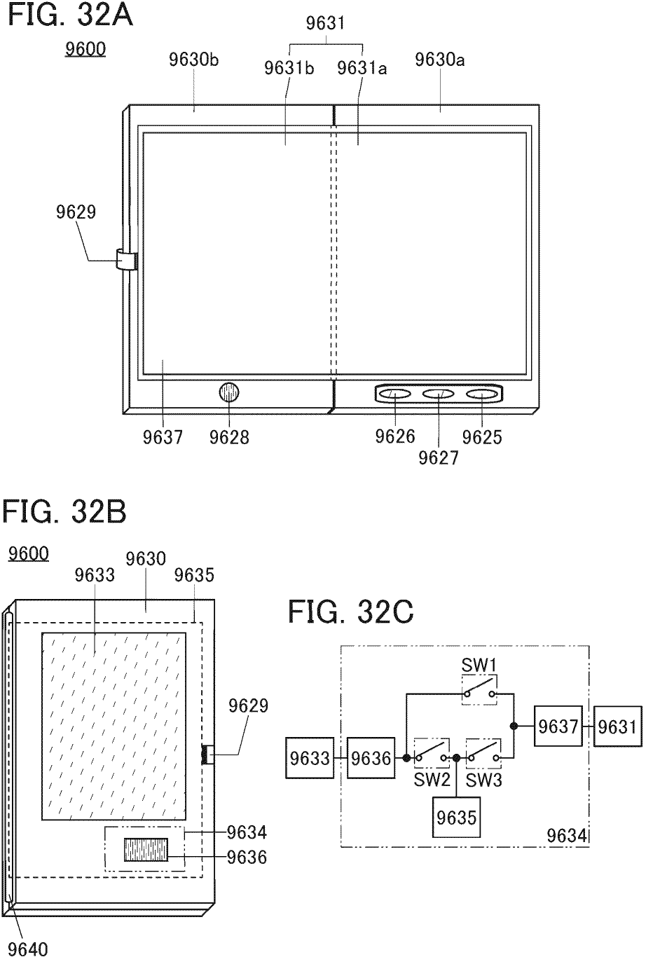

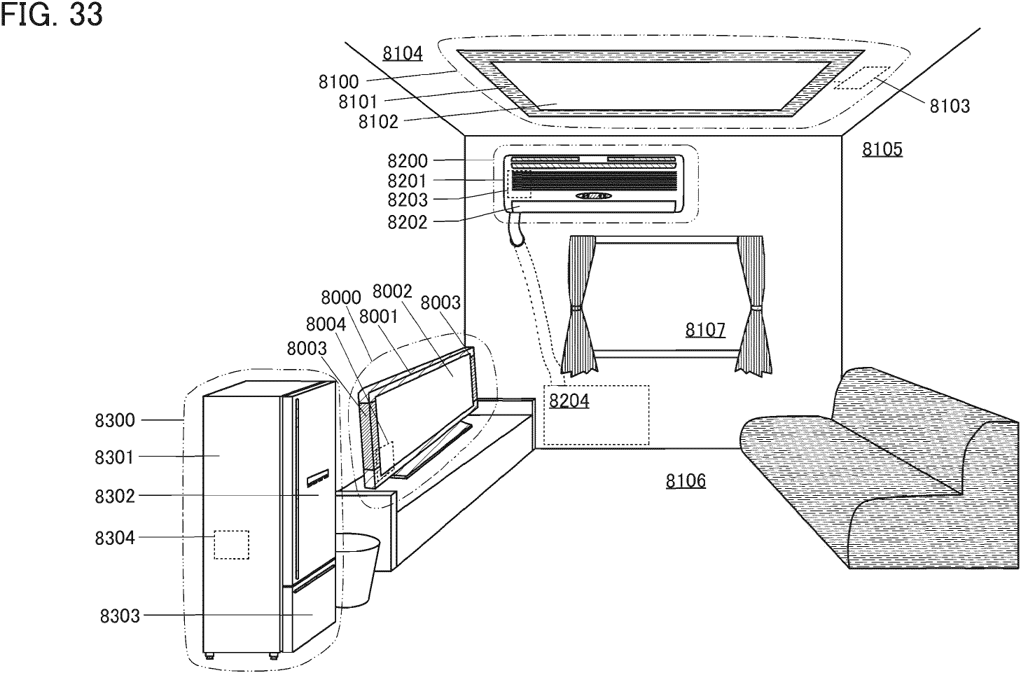

Examples of electronic devices each including the secondary battery with excellent cycle performance described in the above embodiment are described with reference to FIG. 31H, FIG. 32, and FIG. 33.

When the secondary battery of one embodiment of the present invention is used as a secondary battery of an electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 31H is a perspective view of a device called a cigarette smoking device (electronic cigarette). In FIG. 31H, an electronic cigarette 7500 includes an atomizer 7501 including a heating element, a secondary battery 7504 that supplies power to the atomizer, and a cartridge 7502 including a liquid supply bottle, a sensor, or the like. To improve safety, a protection circuit that prevents overcharge and/or overdischarge of the secondary battery 7504 may be electrically connected to the secondary battery 7504. The secondary battery 7504 illustrated in FIG. 31H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIG. 32A and FIG. 32B show an example of a tablet terminal that can be folded in half. A tablet terminal 9600 illustrated in FIG. 32A and FIG. 32B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 32A illustrates the tablet terminal 9600 that is opened, and FIG. 32B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode or a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 32A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-definition images than the other.

The tablet terminal 9600 is folded in half in FIG. 32B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high capacity and excellent cycle performance, the tablet terminal 9600 that can be used for a long time over a long period can be provided.

The tablet terminal 9600 illustrated in FIG. 32A and FIG. 32B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 32B are described with reference to a block diagram in FIG. 32C. The solar cell 9633, the power storage unit 9635, the DCDC converter 9636, a converter 9637, switches SW1 to SW3, and the display portion 9631 are illustrated in FIG. 32C, and the power storage unit 9635, the DCDC converter 9636, the converter 9637, and the switches SW1 to SW3 correspond to the charge and discharge control circuit 9634 illustrated in FIG. 32B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charge may be performed with a non-contact power transmission module that performs charge by transmitting and receiving power wirelessly (without contact), or with a combination of other charge units.

FIG. 33 illustrates other examples of electronic devices. In FIG. 33, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 33, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 33 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 33 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 33, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 33 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 33 as an example, the secondary battery of one embodiment of the present invention can be used in an air conditioner in which the function of an indoor unit and the function of an outdoor unit are integrated in one housing.

In FIG. 33, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 33. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with the other embodiments.

### Embodiment 5

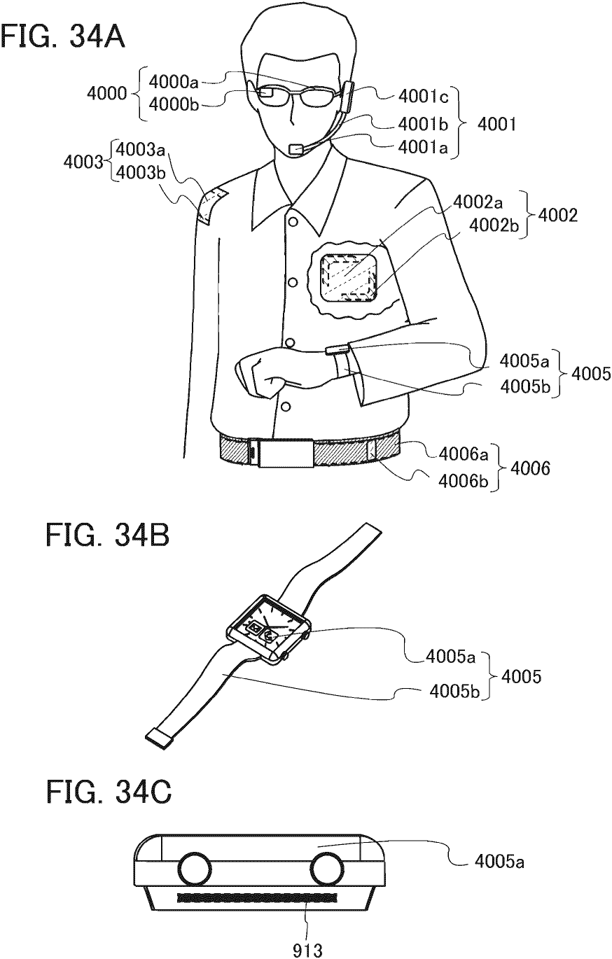

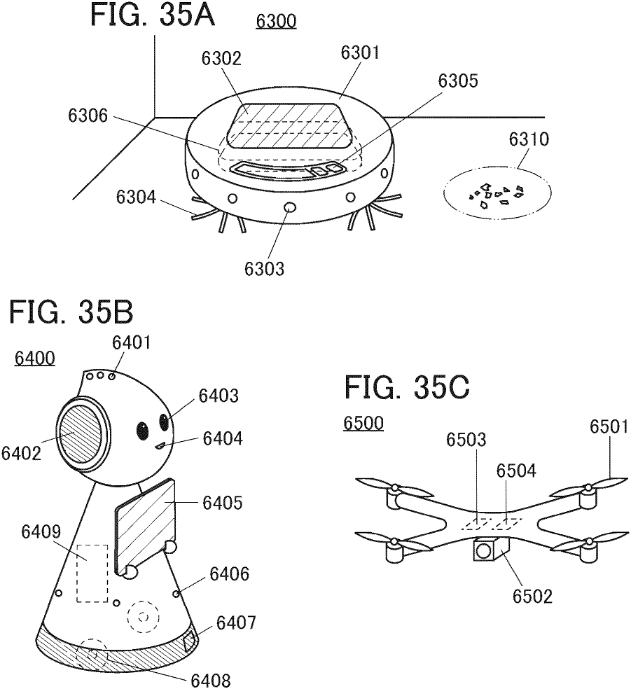

In this embodiment, examples of electronic devices each including the secondary battery described in the above embodiment are described with reference to FIG. 34 to FIG. 35.

FIG. 34A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 34A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and/or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 34B is a perspective view of the watch-type device 4005 that is detached from an arm.

FIG. 34C is a side view. FIG. 34C illustrates a state where the secondary battery 913 is incorporated in the watch-type device 4005. The secondary battery 913 is the secondary battery described in Embodiment 3. The secondary battery 913, which is small and lightweight, overlaps with the display portion 4005a.

FIG. 35A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 35B illustrates an example of a robot. A robot 6400 illustrated in FIG. 35B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 35C illustrates an example of a flying object. A flying object 6500 illustrated in FIG. 35C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 6

In this embodiment, examples of vehicles each including the secondary battery of one embodiment of the present invention will be described.

The use of secondary batteries in vehicles enables production of next-generation clean energy vehicles such as hybrid electric vehicles (HEVs), electric vehicles (EVs), and plug-in hybrid electric vehicles (PHEVs).

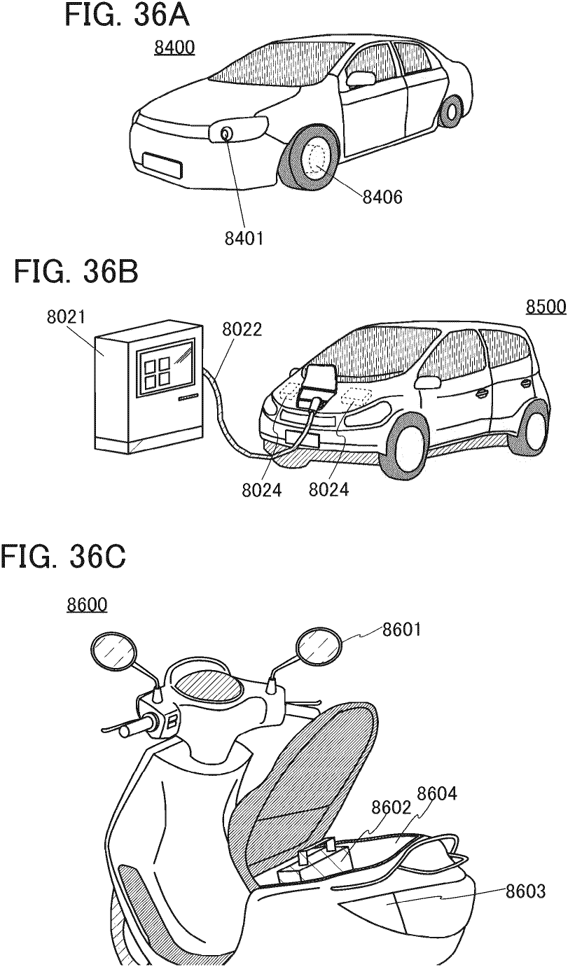

FIG. 36 illustrates examples of a vehicle including the secondary battery of one embodiment of the present invention. An automobile 8400 illustrated in FIG. 36A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the modules of the secondary batteries illustrated in FIG. 19C and FIG. 19D may be arranged to be used in a floor portion in the automobile. Alternatively, a battery pack in which a plurality of secondary batteries illustrated in FIG. 22 are combined may be placed in the floor portion in the automobile. The secondary battery can be used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 36B can be charged when the secondary battery included in the automobile 8500 is supplied with electric power through external charge equipment by a plug-in system, a contactless power feeding system, or the like. FIG. 36B illustrates a state where a secondary battery 8024 included in the automobile 8500 is charged with the use of a ground-based charging apparatus 8021 through a cable 8022. Charging can be performed as appropriate by a given method such as CHAdeMO (registered trademark) or Combined Charging System as a charging method, the standard of a connector, or the like. The charging apparatus 8021 may be a charge station provided in a commerce facility or a power supply in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 36C illustrates an example of a motorcycle including the secondary battery of one embodiment of the present invention. A motor scooter 8600 illustrated in FIG. 36C includes a secondary battery 8602, side mirrors 8601, and direction indicators 8603. The secondary battery 8602 can supply electric power to the direction indicators 8603.

In the motor scooter 8600 shown in FIG. 36C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### [Example 1]

In this example, particle groups of one embodiment of the present invention were formed and evaluated.

According to the steps illustrated in FIG. 3B, the particle group 801 and the particle group 803 were formed.

Lithium carbonate (Li₂CO₃) was prepared as the lithium source. As the element M source, cobalt oxide (Co₃O₄) with the element M being cobalt was prepared.

### <Particle Group 801 and Particle Group 803>

For the particle group 801, the raw materials were prepared so that, when the number of moles of cobalt included in cobalt oxide is 1, the number of moles of lithium included in lithium carbonate can be 1.08 (Li/Co = 1.08/1).

For the particle group 803, the raw materials were prepared so that, when the number of moles of cobalt included in cobalt oxide is 1, the number of moles of lithium included in lithium carbonate can be 1.03 (Li/Co = 1.03/1).

In Step S12, crushing and mixing were performed. Lithium carbonate, cobalt oxide, and a solvent were processed with a ball mill. As the solvent, acetone was used.

The ball mill conditions are described. In forming the particle group 801, 3 mmφ ZrO₂ balls were used and processing was performed at 400 rpm for 2 hours. In forming the particle group 803, 2 mmφ ZrO₂ balls were used and processing was performed at 200 rpm for 12 hours.

Next, in Step S13, annealing was performed. In forming the particle group 801, annealing was performed at 1000° C. for 10 hours in an air atmosphere. In forming the particle group 803, annealing was performed at 950° C. for 10 hours in an air atmosphere.

Through the above-described steps, the particle group 801 and the particle group 803 were obtained.

### <Particle Group 101 and Particle Group 103>

Next, using the particle group 801 and the particle group 803 formed above, the particle group 101 and the particle group 103 were formed.

As the particle group 101, particle groups with five different conditions (hereinafter, particle groups 101_1, 101_2, 101_3, 101_4, 101_5) were formed. The details of each condition are shown in Table 1. As the particle group 103, particle groups with five different conditions (hereinafter, particle groups 103_1, 103_2, 103_3, 103_4, 103_5) were formed. The details of each condition are shown in Table 2.

The particle group 101 and the particle group 103 were formed by the formation method illustrated in FIG. 1A and the formation method illustrated in FIG. 1C, respectively.

First, the mixture 902 was formed. For the formation of the mixture 902, FIG. 3A was referred to. Magnesium fluoride (MgF₂) was prepared as the magnesium source, and lithium fluoride (LiF) was prepared as the fluorine source. The raw materials were prepared so that, when the number of molecules of magnesium fluoride is 1, the number of molecules of lithium fluoride can be 0.33 (MgF₂:LiF = 1:0.33). The prepared raw materials were mixed to obtain the mixture 902.

Next, nickel hydroxide (Ni(OH)₂) and aluminum hydroxide (Al(OH)₃) were prepared as the nickel source and the aluminum source, respectively.

Preparation was performed so that, when the number of cobalt atoms included in the particle group 801 is 100, the ratio among the number of molecules of magnesium fluoride included in the mixture 902, the number of molecules of aluminum hydroxide, and the number of molecules of nickel hydroxide can be as shown in Table 1.

TABLE 1

| | MgF₂ : Ni(OH)₂ : Al(OH)₃ | Temperature |
|---|---|---|
| 101_1 | 1 : 0.5 : 0.5 | 800° C. |
| 101_2 | 2 : 1 : 1 | 800° C. |
| 101_3 | 3 : 1.5 : 1.5 | 800° C. |
| 101_4 | 1 : 0.5 : 0.5 | 700° C. |
| 101_5 | 1 : 0.5 : 0.5 | 900° C. |

Preparation was performed so that, when the number of cobalt atoms included in the particle group 803 is 100, the ratio among the number of molecules of magnesium fluoride included in the mixture 902, the number of molecules of aluminum hydroxide, and the number of molecules of nickel hydroxide can be as shown in Table 2.

TABLE 2

| | MgF₂ : Ni(OH)₂ : Al(OH)₃ | Temperature |
|---|---|---|
| 103_1 | 1 : 0.5 : 0.5 | 800° C. |
| 103_2 | 0.5 : 0.25 : 0.25 | 800° C. |
| 103_3 | 0.2 : 0.1 : 0.1 | 800° C. |
| 103_4 | 1 : 0.5 : 0.5 | 700° C. |
| 103_5 | 1 : 0.5 : 0.5 | 900° C. |

Next, the particle group 801 or 803, the mixture 902, the nickel source, and the aluminum source prepared as described above were mixed to obtain a mixture. Then, the obtained mixture was subjected to annealing at the temperature shown in Table 1 or 2 for 2 hours in an oxygen atmosphere.

Through the above-described steps, the particle groups 101_1, 101_2, 101_3, 101_4, 101_5, 103_1, 103_2, 103_3, 103_4, and 103_5 were obtained.

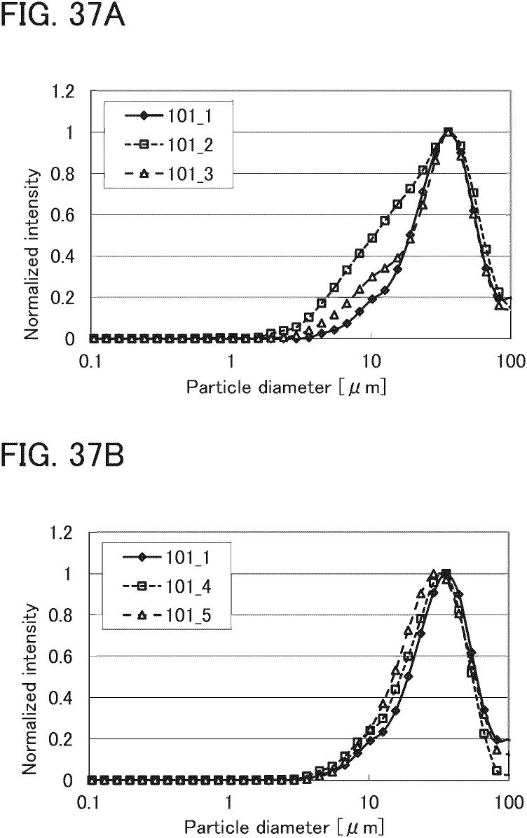

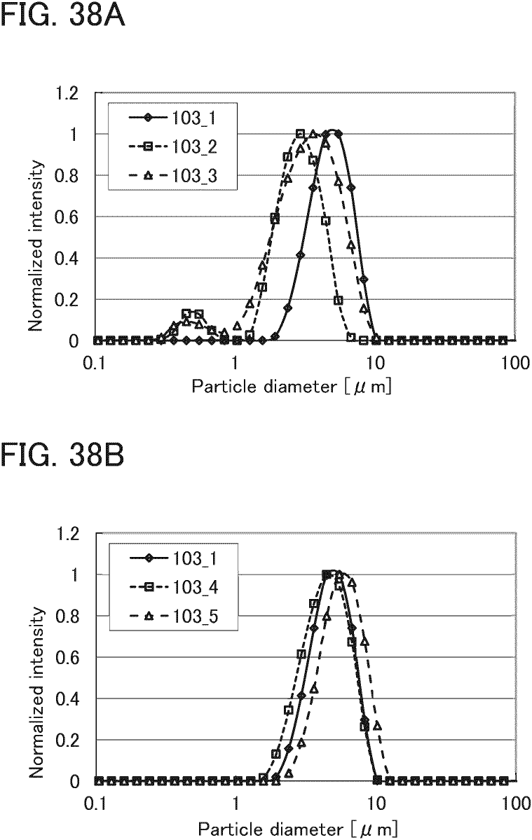

Next, the particle size distribution of each of the obtained particle groups was measured by a laser diffraction and scattering method. The measured particle size distribution is shown in FIG. 37A, FIG. 37B, FIG. 38A, and FIG. 38B. The 10%D, 50%D, 90%D, average particle diameter (Average), and standard deviation (SD) calculated from the measured particle size distribution are shown in Table 3.

TABLE 3

[µm]

| | 10%D | 50%D | 90%D | Average | SD |
|---|---|---|---|---|---|
| 101_1 | 9.543 | 26.216 | 56.220 | 25.132 | 0.311 |
| 101_2 | 6.420 | 23.000 | 54.057 | 20.551 | 0.362 |
| 101_3 | 8.448 | 27.343 | 55.165 | 24.329 | 0.319 |
| 101_4 | 9.898 | 25.719 | 47.518 | 23.527 | 0.266 |
| 101_5 | 10.911 | 25.931 | 54.068 | 25.207 | 0.272 |
| 103_1 | 2.714 | 4.316 | 6.489 | 4.257 | 0.141 |
| 103_2 | 1.363 | 2.504 | 3.965 | 2.260 | 0.247 |
| 103_3 | 1.325 | 2.956 | 5.412 | 2.705 | 0.275 |
| 103_4 | 2.385 | 3.975 | 6.296 | 3.906 | 0.158 |
| 103_5 | 3.248 | 5.176 | 7.880 | 5.116 | 0.143 |

The 50%D of the particle groups 101_1to 101_5 calculated from the particle size distribution was in the range from 23 µm to 28 µm. The 50%D of the particle groups 103_1 to 103_5 calculated from the particle size distribution was in the range from 2 µm to 6 µm, and the particle group 103_2 and the particle group 103_3 with small added amounts of MgF₂, Ni(OH)₂, and Al(OH)₃ showed a tendency of having smaller particle diameters.

### [Reference Numerals]

Reference Numerals

| | |
|---|---|
| 100 | Positive Electrode Active Material |
| 100 a | Surface Portion |
| 100 b | Inner Portion |
| 101 | Particle Group |
| 102 | Particle Group |
| 103 | Particle Group |
| 104 | Particle Group |
| 570 | Electrode |
| 571 | Current Collector |
| 572 | Active Material Layer |
| 581 | Electrolyte |
| 582_1 | Active Material |
| 582_2 | Active Material |
| 582_3 | Active Material |
| 583 | Graphene Compound |
| 801 | Particle Group |
| 802 | Particle Group |
| 803 | Particle Group |
| 902 | Mixture |
| 903 | Mixture |
| 903B | Mixture |
| 903C | Mixture |
| 903D | Mixture |

1. A method for forming an electrode comprising a first particle group, a second particle group, and a third particle group,
wherein a median diameter of the first particle group is greater than a median diameter of the third particle group, and
wherein a median diameter of the second particle group is between the median diameter of the first particle group and the median diameter of the third particle group, the method comprising:
a first step of forming a first mixture including the first particle group, the second particle group, the third particle group, and a solvent;
a second step of applying the first mixture onto a current collector; and
a third step of performing heating to volatilize the solvent,
wherein when weights of the first particle group, the second particle group, and the third particle group in the first mixture are referred to as Mx1, Mx2, and Mx3, respectively, and a sum of Mx1, Mx2, and Mx3 is assumed to be 100, Mx3 is greater than or equal to 5 and less than or equal to 20.

2. A method for forming an electrode, comprising:
a first step of forming a first mixture including a first particle group with a median diameter greater than or equal to 15 µm, a third particle group with a median diameter greater than or equal to 50 nm and less than or equal to 8 µm, a second particle group with a median diameter less than the median diameter of the first particle group and greater than the median diameter of the third particle group, a graphene compound, and a solvent;
a second step of applying the first mixture onto a current collector; and
a third step of performing heating to volatilize the solvent,
wherein the median diameters are each 50%D obtained by particle size distribution measurement using a laser diffraction and scattering method,
wherein the first particle group includes lithium, cobalt, magnesium, and oxygen,
wherein the second particle group includes lithium, cobalt, magnesium, and oxygen,
wherein the third particle group includes lithium, cobalt, and oxygen,
wherein when concentrations of cobalt and magnesium are obtained by analyzing the first particle group by XPS and the concentration of cobalt is assumed to be 1, the concentration of magnesium is greater than or equal to 0.1 and less than or equal to 1.5, and
wherein when concentrations of cobalt and magnesium are obtained by analyzing the second particle group by XPS and the concentration of cobalt is assumed to be 1, the concentration of magnesium is greater than or equal to 0.1 and less than or equal to 1.5 and less than the concentration of magnesium obtained by analyzing the first particle group by XPS.

3. The method for forming an electrode according to claim 2,
wherein in a first particle included in the first particle group, a concentration of magnesium is higher in a surface portion than in an inner portion, and
wherein in a second particle included in the second particle group, a concentration of magnesium is higher in a surface portion than in an inner portion.

4. The method for forming an electrode according to claim 3,
wherein the first particle group includes aluminum,
wherein in the first particle, a concentration of the aluminum is higher in the surface portion than in the inner portion,
wherein the second particle group includes aluminum, and
wherein in the second particle, a concentration of the aluminum is higher in the surface portion than in the inner portion.

5. The method for forming an electrode according to claim 2
wherein when weights of the first particle group, the second particle group, and the third particle group in the first mixture are referred to as Mx1, Mx2, and Mx3, respectively, and a sum of Mx1, Mx2, and Mx3 is assumed to be 100, Mx3 is greater than or equal to 5 and less than or equal to 20.

6. The method for forming an electrode according to claim 2,
wherein the third particle group includes magnesium, and
wherein when concentrations of cobalt and magnesium are obtained by analyzing the third particle group by XPS and the concentration of cobalt is assumed to be 1, the concentration of magnesium is greater than or equal to 0.1 and less than or equal to 1.5.

7. A secondary battery comprising a positive electrode and a negative electrode,
wherein the positive electrode comprises a first particle with a particle diameter greater than or equal to 15 µm, a third particle with a particle diameter greater than or equal to 50 nm and less than or equal to 8 µm, a second particle with a particle diameter greater than the particle diameter of the third particle and less than the particle diameter of the first particle, and a graphene compound,
wherein the first particle comprises lithium, cobalt, magnesium, and oxygen,
wherein the second particle comprises lithium, cobalt, magnesium, and oxygen,
wherein the third particle comprises lithium, cobalt, and oxygen,
wherein in the first particle, a concentration of the magnesium is higher in a surface portion than in an inner portion,
wherein in the second particle, a concentration of the magnesium is higher in a surface portion than in an inner portion, and
wherein the concentration of the magnesium in the surface portion of the first particle is higher than the concentration of the magnesium in the surface portion of the second particle.

8. The secondary battery according to claim 7,
wherein the third particle comprises magnesium, and
wherein the concentration of the magnesium in the surface portion of the second particle is higher than a concentration of the magnesium in a surface portion of the third particle.

9. A secondary battery comprising a positive electrode and a negative electrode,
wherein the positive electrode comprises a first particle with a particle diameter greater than or equal to 15 µm, a third particle with a particle diameter greater than or equal to 50 nm and less than or equal to 8 µm, a second particle with a particle diameter greater than the particle diameter of the third particle and less than the particle diameter of the first particle, and a graphene compound,
wherein the first particle comprises lithium, cobalt, aluminum, and oxygen,
wherein the second particle comprises lithium, cobalt, aluminum, and oxygen,
wherein the third particle comprises lithium, cobalt, and oxygen,
wherein in the first particle, a concentration of the aluminum is higher in a surface portion than in an inner portion,
wherein in the second particle, a concentration of the aluminum is higher in a surface portion than in an inner portion, and
wherein the concentration of the aluminum in the surface portion of the first particle is higher than the concentration of the aluminum in the surface portion of the second particle.

10. The secondary battery according to claim 9,
wherein the third particle comprises aluminum, and
wherein the concentration of the aluminum in the surface portion of the second particle is higher than a concentration of the aluminum in a surface portion of the third particle.

11. The secondary battery according to claim 7
wherein the graphene compound comprises a vacancy formed of a many-membered ring which is a seven- or more-membered ring of carbon.

12. The secondary battery according to claim 7,
wherein the first particle comprises one or more selected from fluorine, bromine, boron, zirconium, and titanium.

13. The secondary battery according to claim 7,
wherein the second particle comprises one or more selected from fluorine, bromine, boron, zirconium, and titanium.

14. The secondary battery according to claim 7,
wherein the third particle comprises nickel, manganese, and aluminum, and
wherein when a sum of concentrations of the cobalt, the manganese, the nickel, and the aluminum in the third particle is assumed to be 100, the concentration of the nickel is greater than or equal to 33.

15. An electronic device comprising the secondary battery according to claim 7.

16. A vehicle comprising the secondary battery according to claim 7.

17. The secondary battery according to claim 9,
wherein the graphene compound comprises a vacancy formed of a many-membered ring which is a seven- or more-membered ring of carbon.

18. The secondary battery according to claim 9,
wherein the first particle comprises one or more selected from fluorine, bromine, boron, zirconium, and titanium.

19. The secondary battery according to claim 9,
wherein the second particle comprises one or more selected from fluorine, bromine, boron, zirconium, and titanium.

20. The secondary battery according to claim 9,
wherein the third particle comprises nickel, manganese, and aluminum, and
wherein when a sum of concentrations of the cobalt, the manganese, the nickel, and the aluminum in the third particle is assumed to be 100, the concentration of the nickel is greater than or equal to 33.
